(19) United States
(12) Patent Application Publication
(10) Pub. No.: US 2016/0162280 A1
(43) Pub. Date: Jun. 9, 2016

(54) INFORMATION PROCESSING APPARATUS AND UPDATE-TIME ESTIMATING METHOD

(71) Applicant: FUJITSU LIMITED, Kawasaki-shi (JP)

(72) Inventors: Takashi MURAYAMA, Nagano (JP); Fumio Matsuo, Nagano (JP); KATSUO ENOHARA, Kawaguchi (JP); Takaaki Yamato, Nagano (JP); Nobuyuki Hirashima, Nagano (JP); Akira BAN, Nagano (JP); Takuya KURIHARA, Nagano (JP); Toshiaki TAKEUCHI, Nagano (JP)

(73) Assignee: Fujitsu Limited, Kawasaki-shi (JP)

(21) Appl. No.: 14/867,497

(22) Filed: Sep. 28, 2015

(30) Foreign Application Priority Data
Dec. 5, 2014 (JP) 2014-246882

(51) Int. Cl. G06F 9/445

(52) U.S. Cl. CPC G06F 8/65

(57) ABSTRACT

An information processing apparatus, for managing a target apparatus including a plurality of modules for which a plurality of update processes of software are executed, includes a specification unit to specify one or more first process blocks from among the update processes for the modules of the target apparatus based on execution order information indicating an execution order of the update processes, each first process block including a plurality of update processes to be executed in parallel, a first estimating unit to estimate an update time for each specified first process block, using update time information indicating an update time taken for each of the update processes, and a second estimating unit to estimate a total update time for the target apparatus, using the update time information and the estimated update time for each specified first process block.

### CROSS-REFERENCE TO RELATED APPLICATION

This application is based upon and claims the benefit of priority of the prior Japanese Patent Application No. 2014-246882, filed on Dec. 5, 2014, the entire contents of which are incorporated herein by reference.

### FIELD

The embodiments discussed herein are related to an information processing apparatus and an update-time estimating method.

### BACKGROUND

For a system including a server, a storage, a network device, and the like, firmware of some devices in the system is sometimes updated (hereinafter, referred to also as firmware update).

In such a system, during the firmware update of some devices, the operation of the system concerned is temporarily stopped in consideration of influence of the update on the other devices. For this reason, the operator in charge of the firmware update determines a time zone during which the firmware update of some devices may be conducted, in view of an operation schedule of the system, and determines the schedule of the firmware update.

Meanwhile, a complex system including a plurality of devices in combination is sometimes subjected to firmware update (a target apparatus). Examples of such a complex system include an apparatus including a plurality of devices (components) and being configured in the form of a product having another unique function by combining components each commercialized. Another example of the complex system is an apparatus including a plurality of modules including a central processing unit (CPU), a memory, and the like, and being configured such that functions to control the entire apparatus are separately assigned to the modules, and the function of each of the modules is controlled by firmware.

Hereinafter, as an example of such a complex system, a virtual tape library apparatus is described. The virtual tape library apparatus may incorporate, for example, components such as a control device, a redundant array of inexpensive disks (RAID) device, a local area network (LAN) hub, a Fibre Channel (FC) switch, a power supply control device, and a tape library device.

As illustrated in FIG. 33, the virtual tape library apparatus has a plurality of models and optional configurations, and the types and numbers of constituent components to be mounted vary depending on these configurations. In an example of FIG. 33, the basic configuration of a model A includes a control device, a RAID device, a LAN hub, an FC switch, a power supply control device, and a tape library device A. The basic configuration of a model B is different from the basic configuration of the model A in that the FC switch is removed and the tape library device A is replaced with a tape library device B having a product specification different from that of the tape library device A. Moreover, the basic configuration of a model C is different from the basic configuration of the model A in that the tape library device A is replaced with a tape library device C having a product specification different from that of the tape library device A. A multi-Library (LIB) configuration, which is an optional configuration, of the model C is different from the basic configuration of the model C in that two tape library devices C are provided.

In the firmware update of the virtual tape library apparatus, an update firmware set in which pieces of update firmware for the respective components are combined is provided. The operator updates each component with a designated firmware version. The update is conducted based on an update procedure (hereinafter called an update flow) defined in advance for each model (for each device configuration) in accordance with the configuration of the virtual tape library apparatus.

FIG. 34 is a diagram illustrating a relation between update flows defined individually for the models and an estimated time for total firmware update. As illustrated in FIG. 34, the models A to C have different components to be mounted therein from one another and thus have different update flows from one another. Accordingly, the estimated time for total firmware update is also different among the models A to C. Note that the update flows illustrated in FIG. 34 are intended to clearly illustrate differences among the models for the sake of explanation, and are different from actual update flows of the models A to C illustrated in FIG. 33.

In the firmware update of the virtual tape library apparatus, the operator conducts firmware update for each component in accordance with the update flows (a procedure manual) illustrated in FIG. 34.

Next, an example of a procedure for the operator to conduct the firmware update of a complex system is described with reference to FIG. 35.

First, the operator determines a target model for firmware update, and obtains a corresponding update flow (Step S101), and selects a component to be subjected to the firmware update in accordance with the update flow (Step S102). Then, the operator determines whether or not the version of the selected component has been changed (Step S103).

When the version of the selected component has been changed (Yes route in Step S103), the operator takes out the firmware for the target component from the update firmware set, and conducts firmware update for the target component (Step S104). The processing then proceeds to Step S105. When the version of the selected component has not been changed (No route in Step S103), the processing proceeds to Step S105 as well.

In Step S105, the operator determines whether or not there is another component capable of firmware update in parallel in the constituent components. When there is such a component (Yes route in Step S105), the processing proceeds to Step S103. On the other hand, when there is no component capable of firmware update in parallel (No route in Step S105), the operator waits for completion of the firmware update for each component (Step S106, S106 in No route)

When there is any component for which the firmware update has been completed (Yes route in Step S106), the operator determines whether or not any constituent component that has become capable of the firmware update (Step S107). When there is such a component (Yes route in Step S107), the processing proceeds to Step S103. On the other hand, when there is no constituent component that has become capable of the firmware update (No route in Step S107), the operator determines whether or not the update for all the constituent components has been completed (Step S108). When the update has not been completed (No route in Step S108), the processing proceeds to Step S106.

When the update is completed for all the constituent components (Yes route in Step S108), the processing is terminated.

Note that as an approach to calculate the update time for firmware, various techniques are known (see, for example, Japanese Laid-open Patent Publication Nos. 2007-334636 and 2003-058335).

In addition, related conventional techniques are disclosed in, for example, Japanese Laid-open Patent Publication Nos. 2008-152482 and 2012-043187.

However, the estimated time for total firmware update of a complex system such as a virtual tape library apparatus varies depending on the defined update flow (update procedure), as well as, the presence or absence and estimated time of firmware update for each component, and the like, as illustrated in FIG. 34.

When a complex system is entirely active, it is difficult to perform firmware update of the complex system. In this case, the firmware update of the complex system is conducted separately from the entire system.

For this reason, a department or the like that uses a target apparatus for firmware update desirably prepares a system operation schedule for conducting firmware update for the target apparatus, in advance.

However, in the firmware update of the complex system as the target apparatus, modules of a plurality of components and the like are processed in accordance with the update flow. For this reason, it is difficult to easily obtain the estimated time for total firmware update, which is taken for the firmware update of the entire target apparatus.

### SUMMARY

According to an aspect of the invention, an information processing apparatus, for managing a target apparatus including a plurality of modules for which a plurality of update processes of software are executed, includes a specification unit to specify one or more first process blocks from among the update processes for the modules of the target apparatus based on execution order information indicating an execution order of the update processes for the modules of the target apparatus, each first process block including a plurality of update processes to be executed in parallel, a first estimating unit to estimate an update time for each specified first process block, using update time information indicating an update time taken for each of the update processes for the modules of the target apparatus, and a second estimating unit to estimate a total update time for the target apparatus, using the update time information and the estimated update time for each specified first process block.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an update flow for a complex system;

FIG. 2 is a diagram illustrating an example of firmware update times for respective component of the complex system;

FIG. 3 is a diagram illustrating an example of a route of the longest update time when the firmware update times illustrated in FIG. 2 are applied to the update flow illustrated in FIG. 1;

FIG. 4 is a diagram illustrating a configuration example of a system according to an embodiment;

FIG. 5 is a diagram illustrating a detailed configuration example of the system according to the embodiment;

FIG. 6 is a diagram illustrating a configuration example of an operation console according to the embodiment;

FIG. 7 is a diagram illustrating an example of a flow table of an update flow database;

FIG. 8 is a diagram for explaining an example of a main route;

FIG. 9 is a diagram for explaining an example of a branch route;

FIG. 10 is a diagram illustrating an example of an element management table of the update flow database;

FIG. 11 is a diagram illustrating an example of a case where component firmware update processes are added to the element management table of the update flow database illustrated in FIG. 10;

FIG. 12 is a diagram for explaining an example of a branching point;

FIG. 13 is a diagram for explaining an example of a joining point;

FIG. 14 is a diagram illustrating an example of an approach to generate a firmware update procedure based on the update flow database;

FIG. 15 is a diagram illustrating another configuration example of the system according to the embodiment;

FIG. 16 is a diagram for explaining an example of a process block dividing process conducted by a block dividing section according to the embodiment;

FIG. 17 is a diagram for explaining an example of a process block dividing process conducted by the block dividing section according to the embodiment;

FIG. 18 is a diagram for explaining an example of a block route specifying process conducted by the block dividing section according to the embodiment;

FIG. 19 is a diagram for explaining an example of a block route specifying process conducted by the block dividing section according to the embodiment;

FIG. 20 is a diagram illustrating an example of a firmware update time database;

FIG. 21 is a flowchart for explaining an example of an update time estimating process conducted by a firmware update time estimating unit according to the embodiment;

FIG. 22 is a flowchart for explaining an example of a DB selecting process conducted by a DB selecting section according to the embodiment;

FIG. 23 is a flowchart for explaining an example of a block dividing process conducted by the block dividing section according to the embodiment;

FIG. 24 is a flowchart for explaining an example of a firmware update time selecting process conducted by an estimated time selecting section according to the embodiment;

FIG. 25 is a flowchart for explaining an example of a block estimated time calculating process conducted by a first calculating section according to the embodiment;

FIG. 26 is a diagram illustrating an update flow of a complex system according to an example;

FIG. 27 is a diagram illustrating a firmware update time database according to the example;

FIG. 28 is a diagram illustrating a flow table of an update flow database according to a first example;

FIG. 29 is a diagram illustrating a result of calculation of an estimated time for total firmware update according to the first example;

FIG. 30 is a diagram illustrating a flow table of an update flow database according to a second example;

FIG. 31 is a diagram illustrating a result of calculation of an estimated time for total firmware update according to the second example;

FIG. 32 is a hardware configuration example of the operation console according to the embodiment;

FIG. 33 is a diagram illustrating configuration examples of models and options of virtual tape library apparatuses;

FIG. 34 is a diagram illustrating a relation between estimated times for total firmware update and update flows defined individually for the models; and

FIG. 35 is a flowchart for explaining an example of a procedure of performing a firmware update for a complex system.

### DESCRIPTION OF EMBODIMENTS

Hereinafter, an embodiment is described with reference to the drawings. Note that in the drawings used for the following embodiment, parts denoted by the same reference signs represent the same or similar parts unless otherwise stated.

Estimated Time for Total Firmware Update for Complex System

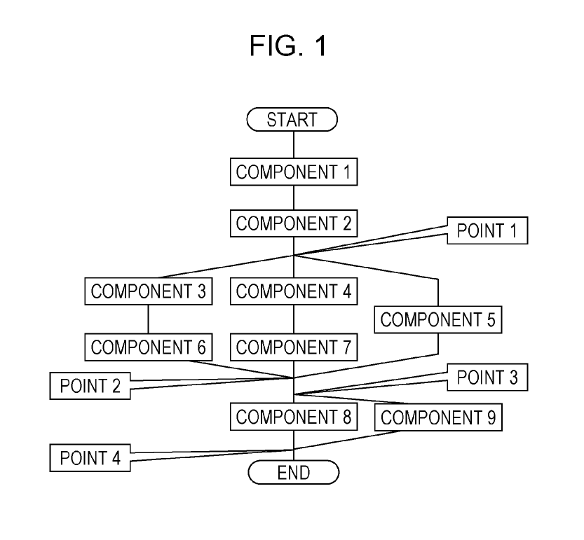

First, an estimated time for total firmware update for a complex system is described with reference to FIGS. 1 to 3.

Hereinafter, description is given on the assumption that the complex system includes 9 components, that is, a component 1 to a component 9, and that an update flow illustrated in FIG. 1 is defined.

When performing the firmware update for the complex system, the operator may theoretically simulate a process for the firmware update illustrated in FIG. 1, and find an estimated time of the entire target apparatus for in procedures described below.

(a) It is investigated whether firmware update is present or not for each component from version information on the firmware applied to the complex system. (b) A firmware update time for each component is assigned to the update flow to be used. (c) A time taken for firmware update of the entire device, which is subjected to the firmware update, is calculated in accordance with the update flow.

Here, in the update flow illustrated in FIG. 1, a point 1 and a point 3 each indicate a branching point representing at which the processing branches such that firmware update is conducted for a plurality of components in parallel. In addition, a point 2 and a point 4 each indicate a joining point representing at which a plurality of divided branch routes join. At each joining point, the processing proceeds to the next after the processing of all the branch routes to which the processing has branched at the corresponding branching point is completed.

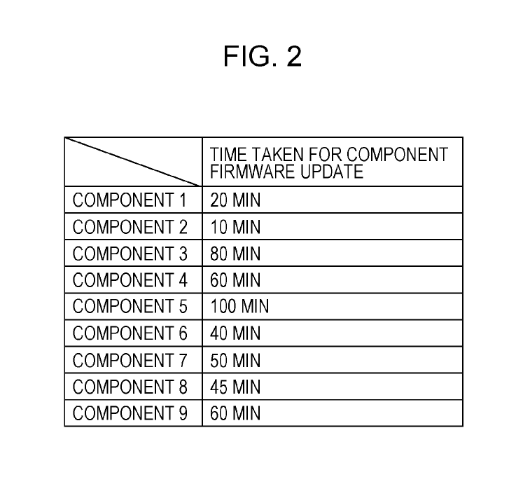

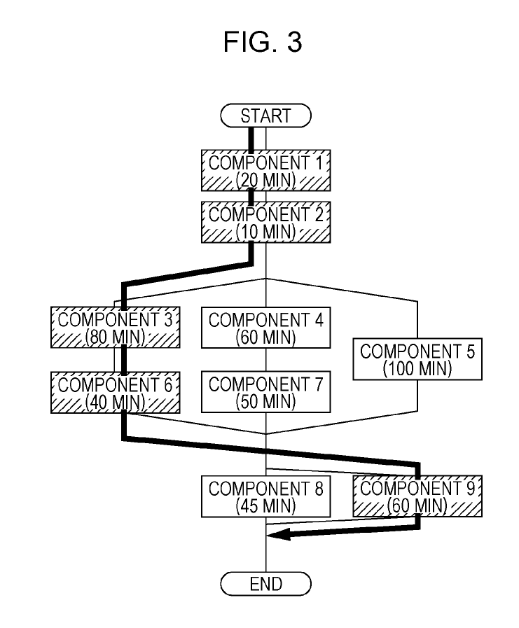

FIG. 2 illustrates an example of the firmware update time for each component of the complex system. When the firmware update times illustrated in FIG. 2 is applied to the update flow illustrated in FIG. 1, it is found that a route indicated by an arrow (the component 1, the component 2, the component 3, the component 6, and the component 9) takes the longest time as illustrated in FIG. 3, this time serves as the estimated time for total firmware update of the complex system.

Specifically, in the example illustrated in FIG. 3, among the branch routes from the point 1 to the point 2, the route in which firmware update is performed for the component 3 and the component 6 takes longer time than the remaining 2 routes (the route for the component 4 and the component 7 and the route for the component 5). Thus, at the point 2, the completion of the route for the component 3 and the component 6 is waited even though the remaining 2 routes are completed.

In addition, among the branch routes from the point 3 to the point 4, the time taken for the firmware update of the component 9 is longer than the time taken for the firmware update of the component 8. Thus, at the point 4, the completion of the route for the component 9 is waited even though the route for the component 8 is completed.

Accordingly, in the example illustrated in FIG. 3, the estimated time for total firmware update of the complex system using the update flow illustrated in FIG. 1 is such that the component 1 (20 minutes)+the component 2 (10 minutes)+the component 3 (80 minutes)+the component 6 (40 minutes)+the component 9 (60 minutes)=the estimated time for total firmware update (210 minutes).

As described above, the update time taken for the firmware update of the complex system is estimated (calculated) theoretically by the operator. Thus, the calculation of the update time becomes complicated depending on the scale of the complex system, making it difficult for the operator to easily obtain the update time.

In view of this, a system according to an embodiment employs an approach described below in detail to enable the update time to be easily estimated for a target apparatus including a plurality of modules for which software update processes are performed.

Configuration Example of System

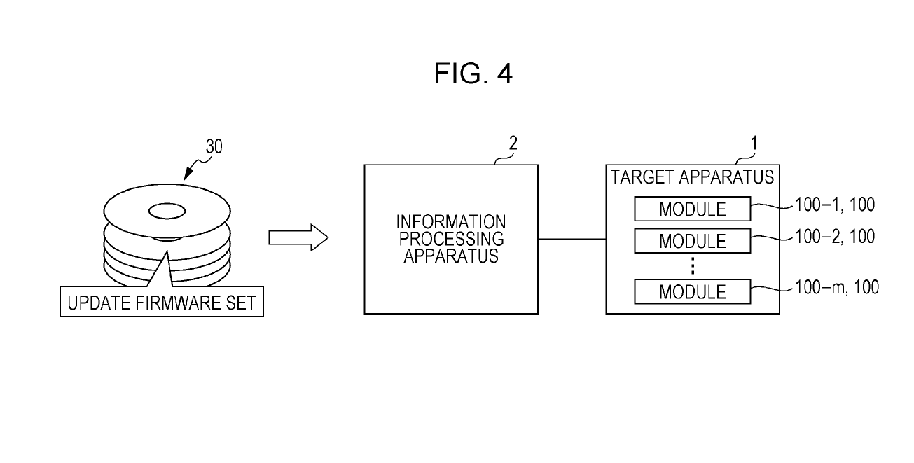

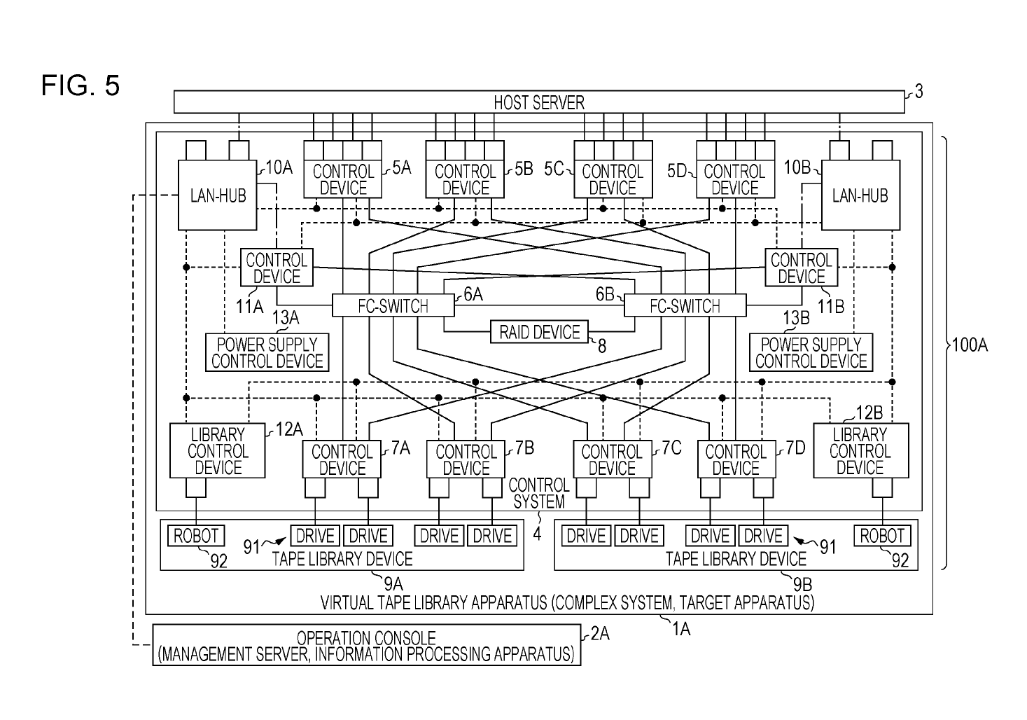

Hereinafter, a configuration example of the system according to the embodiment is described with reference to FIGS. 4 and 5. As illustrated in FIG. 4, the system according to the embodiment includes a target apparatus 1 and an information processing apparatus 2 that manages the target apparatus 1.

The target apparatus 1 includes a plurality of modules 100-1 to 100-m (in the example illustrated in FIG. 4, m modules, where m is a natural number) as constituent components. Hereinafter, when not distinguished, these modules 100-1 to 100-m are each simply called the module 100. The target apparatus 1 may be a complex system, for example.

To the information processing apparatus 2, an update firmware set 30 provided by a developer such as a vendor of the target apparatus 1, for example, is inputted, and the information processing apparatus 2 then manages the application of the update firmware set 30 to the corresponding target apparatus 1 (updating of the firmware for each of the plurality of modules 100). This management includes a process of estimating the update time for the firmware update using the update firmware set 30 on the target apparatus 1. This management may also include a process of applying (updating) the update firmware set 30 to the target apparatus 1.

Next, a detailed configuration example of the system illustrated in FIG. 5 is described. As illustrated in FIG. 5, the system includes a virtual tape library apparatus 1A, an operation console 2A (an example of the information processing apparatus 2 in FIG. 4), and a host server 3.

The virtual tape library apparatus 1A is an apparatus that provides a virtual tape library to the host server 3, and includes a control system 4 and one or more tape library devices 9A and 9B (in the example illustrated in FIG. 5, 2 tape library devices). The virtual tape library apparatus 1A is an example of the complex system (corresponding to the target apparatus 1 in FIG. 4).

Each of the tape library devices 9A and 9B houses a plurality of tape cartridges which are an example of medium cartridges that store data, and accesses the tape cartridges in accordance with an access request from the host server 3. Each of the tape library devices 9A and 9B includes: a plurality of drives 91 that record and reproduce data to and from the tape cartridges; and a robot 92 that performs picking up of the tape cartridges, transportation of the tape cartridges, insertion of the tape cartridges into the drives 91.

The control system 4 includes control devices 5A to 5D, 7A to 7D, and 11A and 11B, FC switches 6A and 6B, a RAID device 8, LAN hubs 10A and 10B, library control devices 12A and 12B, as well as power supply control devices 13A and 13B.

The control devices 5A to 5D are each connected to the host server 3 via a physical layer (PHY) by a plurality of host I/F (Interface) buses, and perform access control with the host server 3. The control devices 7A to 7D are each connected to the drives 91 via FCs, and perform access control with the drives 91. Note that the control devices 5A to 5D are an example of a channel adapter (CA), and the control devices 7A to 7D are an example of a device adapter (DA).

The FC switches 6A and 6B perform data transfer (switching) between the control devices 5A to 5D and the control devices 7A to 7D connected via FCs. The RAID device 8 is connected to the FC switches 6A and 6B via FCs and temporarily stores data (read/write data) regarding access between the host server 3 and the tape library device 9A or 9B. The RAID device 8 plays a role as a cache in the virtual tape library apparatus 1A. Meanwhile, the RAID device 8 may include at least one of magnetic disk devices such as a hard disk drive (HDD) and semiconductor drive devices such a solid state drive (SSD). Alternatively, the RAID device 8 may be used as a primary storage for hierarchical management. In this case, the RAID device 8 operates as the virtual tape library apparatus 1A, enabling high-speed access, and data in the RAID device 8 is written to a tape of the tape library devices 9A and 9B serving as a secondary storage in accordance with an unload instruction.

The LAN hubs 10A and 10B are connected to the operation console 2A, the control devices 5A to 5D, 7A to 7D, and 11A and 11B, the library control devices 12A and 12B, as well as the power supply control devices 13A and 13B via an internal control bus, and transfer control signals between these devices.

The control devices 11A and 11B perform various controls such as setting of each device and acquisition of information in the control system 4 via the LAN hubs 10A and 10B. Meanwhile, the host server 3 or the operation console 2A is connected to the control devices 11A and 11B via a control bus, and the control devices 11A and 11B perform communications with the host server 3 or the operation console 2A.

The library control devices 12A and 12B perform a drive control and the like of the robot 92. The power supply control devices 13A and 13B perform ON/OFF control of a power supply for each device connected to a power supply device which is not illustrated.

The function of each of the above-described devices 5A to 5D, 6A and 6B, 7A to 7D, 8, 9A and 9B, 10A and 10B, 11A and 11B, 12A and 12B, as well as 13A and 13B is at least partially controlled by firmware (software). In addition, the firmware of each of the above-described devices may be updated by a plurality of pieces of update firmware included in the update firmware set 30 illustrated in FIG. 4. In other words, the virtual tape library apparatus 1A may have a firmware update function of updating the firmware of each of the above-described devices.

As described above, each of the above-described devices may be expressed as a module 100A similar to the module 100 illustrated in FIG. 4. In addition, the virtual tape library apparatus 1A is an example of the complex system (target apparatus 1) including a plurality of the modules 100A.

The operation console 2A is an example of a management server that performs management (control) of the virtual tape library apparatus 1A via an interface (the LAN hubs 10A and 10B) of the virtual tape library apparatus 1A. For example, the operation console 2A may read the update firmware set 30 of the virtual tape library apparatus 1A and perform calculation of an estimated time for total firmware update, which is described later in detail, execution of a firmware update process, and the like, at the time of firmware update of the virtual tape library apparatus 1A.

The host server 3 is a server that performs access to the virtual tape library apparatus 1A, and is used, for example, by a user of the virtual tape library apparatus 1A, or the like.

The operation console 2A and the host server 3 each may be a computer (an information processing apparatus) such as a PC or a server.

Configuration Example of Operation Console

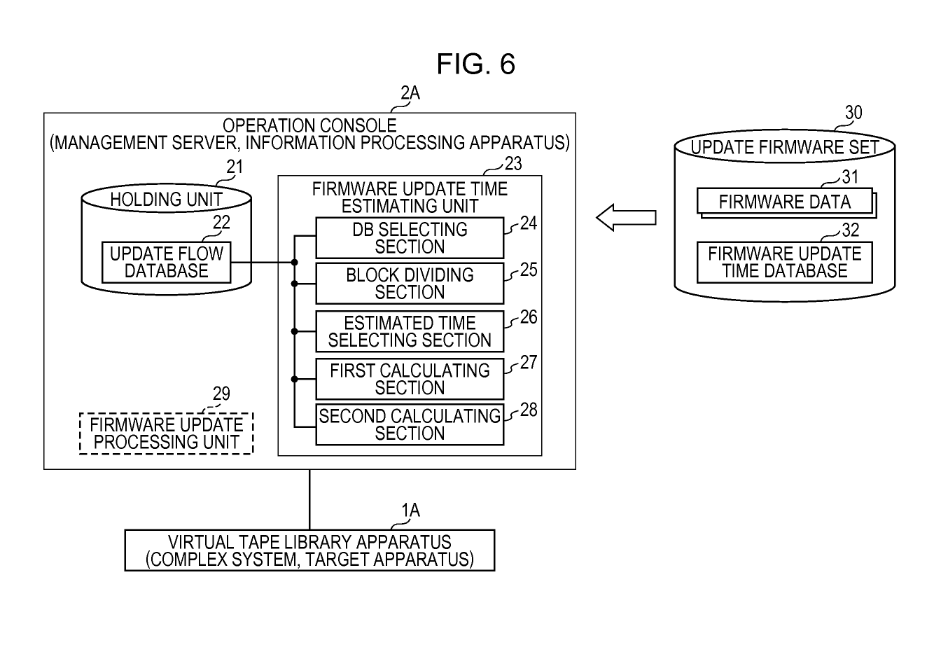

Next, a configuration example of the operation console 2A according to the embodiment is described with reference to FIG. 6. The operation console 2A is connected to the virtual tape library apparatus 1A via a LAN or the like. In addition, the update firmware set 30 is inputted to the operation console 2A.

The update firmware set 30 includes a plurality of pieces of firmware data 31 and a firmware update time database 32. The plurality of pieces of firmware data 31 are firmware for update to be applied to the plurality of modules 100A included in the virtual tape library apparatus 1A as the target apparatus 1. Note that the firmware update time database 32 is described later.

When the update firmware set 30 is inputted (provided), the operation console 2A may hold the plurality of pieces of firmware data 31 and the firmware update time database 32 in a storage device, for example, a holding unit 21.

The operation console 2A includes the holding unit 21 and a firmware update time estimating unit 23 as illustrated in FIG. 6. Note that the operation console 2A may include a firmware update processing unit 29.

The holding unit 21 is an example of a storage device that stores data, and holds an update flow database 22, as illustrated in FIG. 6. The update flow database 22 contains information in which constituent components and an update order of the constituent components (an execution order of firmware update processes) are defined for each of all the complex systems managed by the operation console 2A. In addition, information on times taken for the firmware update of the respective constituent components, which is contained in the update firmware set 30, may be set in the update flow database 22.

The update flow database 22 is generated and set in the holding unit 21 in advance by an administrator or the like of the system or the virtual tape library apparatus 1A at a predetermined timing such as start of operation, or change in configuration, of the system or the virtual tape library apparatus 1A.

Description of Update Flow Database

Hereinafter, the update flow database 22 is described. Note that for the sake of convenience, the following description is made on the assumption that the virtual tape library apparatus 1A includes 9 constituent components (modules 100A), that is, the component 1 to the component 9, and the firmware update is conducted in accordance with the update flow illustrated in FIG. 1.

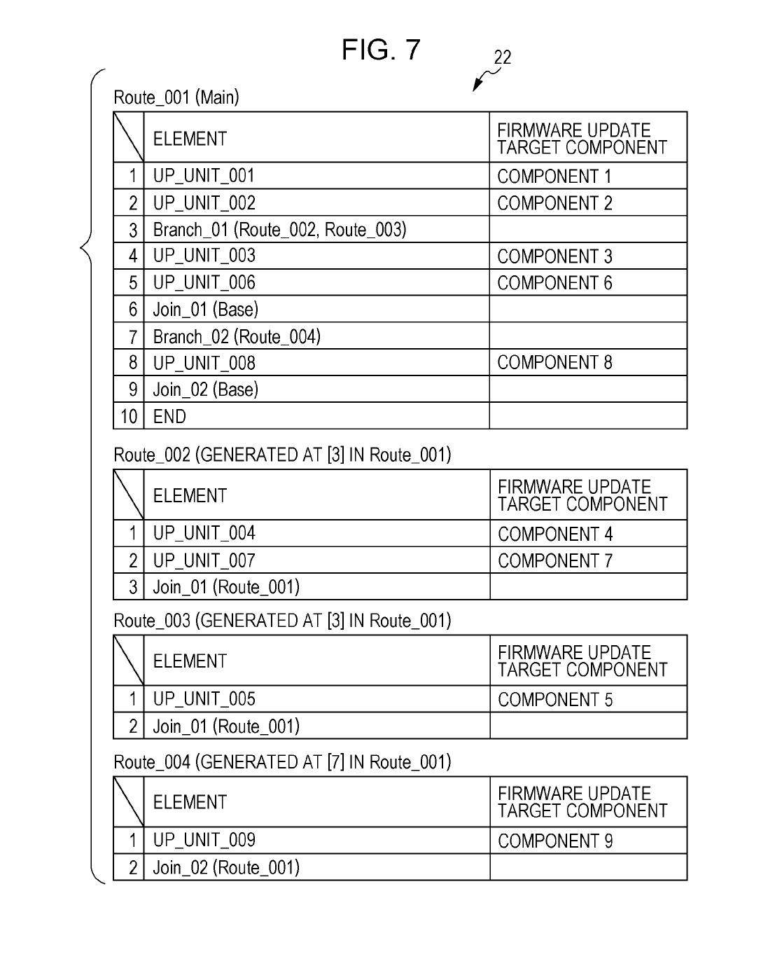

FIG. 7 is a diagram illustrating an example of flow tables of the update flow database 22. As illustrated in FIG. 7, the update flow database 22 is formed by defining the update flow (the procedure manual) illustrated in FIG. 1 as database for automatic calculation of the estimated time for total firmware update, and contains a plurality of flow tables (4 flow tables in the example of FIG. 7).

Each of the flow table indicates one route, and each route is a collection of list structures including at least one of a “component firmware update process (UP_UNIT_xxx)”, a “branching point (Branch_xx)”, and a “joining point (Join_xx)”, which are processing elements.

One of the flow tables represents the main route of the update flow (Route_001 in the example illustrated in FIG. 7), and the flow tables other than the main route represent branch routes that branch from the main route (Route_002 to Route_004 in the example illustrated in FIG. 7).

Each route (Route_xxx) has a list structure, and indicates a flow in which the processing is conducted in the order of the list. To define a plurality of components being subjected to firmware update in parallel (simultaneously), not one route but the same number of routes as that of the components are used. For this reason, to subject a plurality of components to firmware update in parallel, a plurality of branch routes (Route_xxx) are generated in advance by use of branching points (Branch_xx).

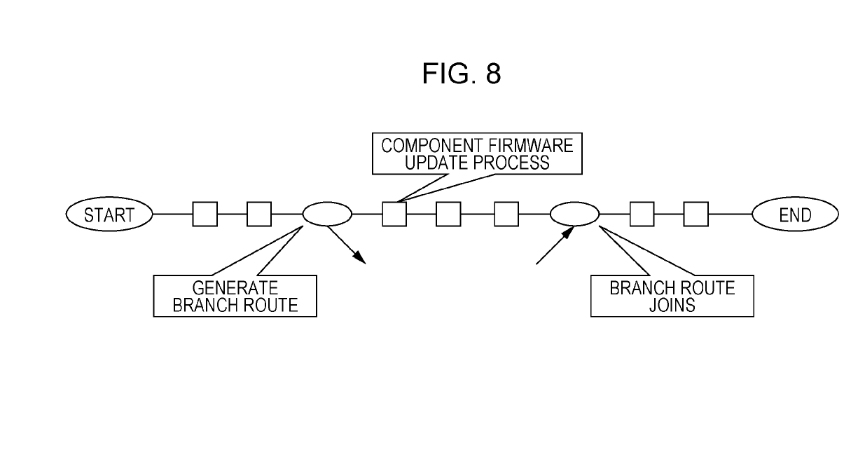

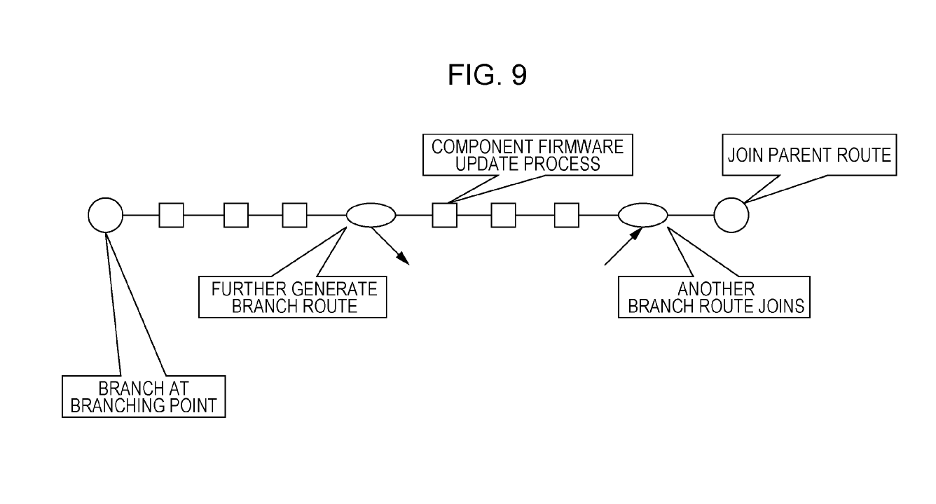

FIG. 8 is a diagram illustrating an example of the main route (Route_001). FIG. 9 is a diagram illustrating an example of the branch route (Route_xxx). Once the firmware update of the virtual tape library apparatus 1A is started, the main route (Route_001) is first processed as illustrated in FIG. 8, and then, the component firmware update process, generation of a branch route, joining of a branch route, and the like are conducted. For each branch route as well, as illustrated in FIG. 9, the component firmware update process, generation of a further branch route, joining of another branch route, and the like are conducted in parallel with the processing for the parent route (the main route or a branch route of the branch source). Since the branch route eventually joins the main route. For this reason, once the main route is completed, the firmware update processes for all the components of the virtual tape library apparatus 1A is completed.

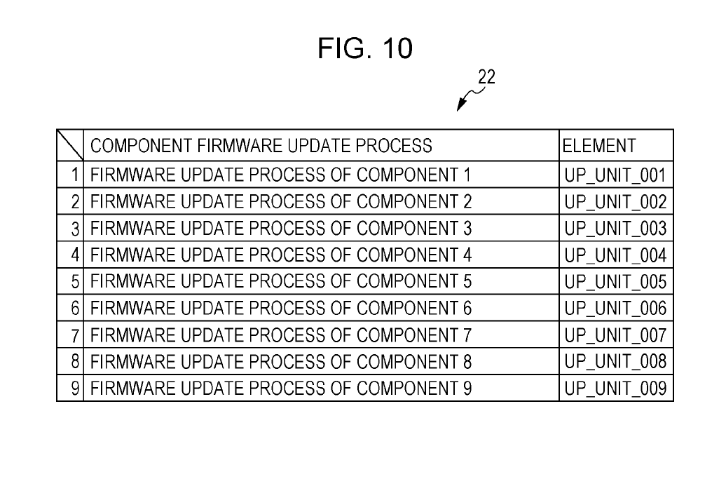

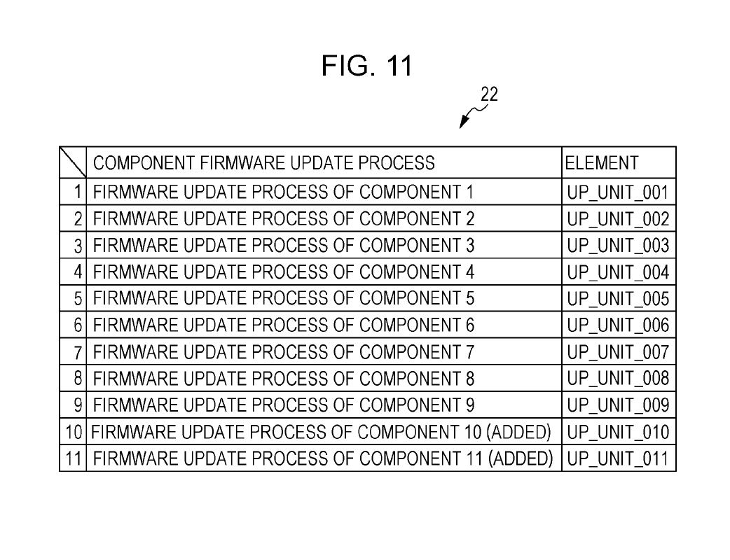

FIG. 10 is a diagram illustrating an example of an element management table of the update flow database 22. FIG. 11 is a diagram illustrating an example of a case where component firmware update processes are added to the element management table of the update flow database 22 illustrated in FIG. 10. The component firmware update process (UP_UNIT_xxx) is a point (processing element) indicating the process of conducting the firmware update for each component. The component corresponding to UP_UNIT_xxx is associated with UP_UNIT_xxx in an element management table contained in the update flow database 22, as illustrated in FIG. 10. As one example, the firmware update process of the component 1 is associated with UP_UNIT_001 as illustrated in FIG. 10.

As illustrated in FIG. 10, the component firmware update process (UP_UNIT_xxx) is information capable of uniquely specifying each of all the components 1 to 9 of the virtual tape library apparatus 1A. When a constituent component is added or changed in the virtual tape library apparatus 1A due to addition of a new model or the like, a new constituent component may be added to the element management table as illustrated in FIG. 11 (see the component 10 and the component 11).

The branching point (Branch_xx) is a point (processing element) where a route is branched, that is, a point that enables parallel conduct of the firmware update. At Branch_xx, one route (Route_xxx) or more are newly generated, enabling the firmware update of components in parallel for the number of routes. Note that as indicated by Route_001 in FIG. 7, one Route_xxx or more in the parentheses ( ) added after Branch_xx indicates a route generated by Branch_xx.

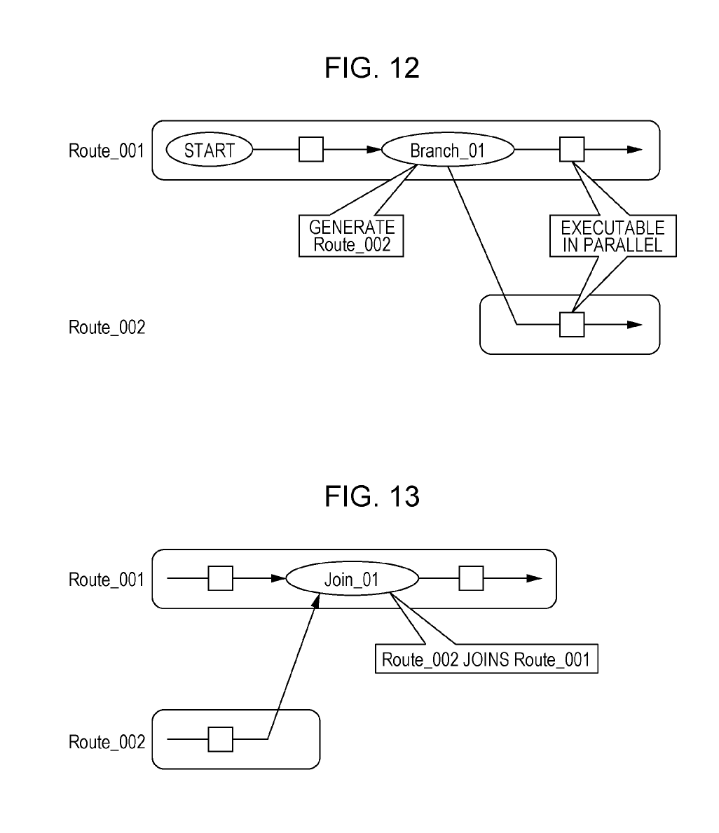

FIG. 12 is a diagram for explaining an example of the branching point. As illustrated in FIG. 12, in the update flow defined as a database, a flow of the main route (Route_001) is generated at the time of starting the firmware update. When a branching point (Branch_xx) is defined in the flow of Route_001, a new route (Route_xxx) indicated by the branching point (Branch_xx) is generated, enabling a plurality of firmware update processes for components to be conducted in parallel for the number of branch routes.

The joining point (Join_xx) is a point (processing element) where routes join, that is, a point where parallel conduct of the firmware update is terminated. At Join_xx, two routes or more join to return into one route in the flow of the processing. Note that as illustrated in FIG. 7, when Base is present in parentheses ( ) added after Join_xx (see Route_001 in FIG. 7), it indicates a joining point where routes including the Join_xx join. On the other hand, when not Base but Route_xxx is present in parentheses ( ) added after Join_xx (see Route_002 to Route_004), it indicates that the route including the Join_xx joins the route specified by Route_xxx in the parentheses, and the route including the Join_xx is terminated (vanishes).

FIG. 13 is a diagram for explaining an example of the joining point. As illustrated in FIG. 13, branch routes join at the joining point (Join_xx), the branch routes other than the branch route of the lowest number are terminated. In the example illustrated in FIG. 13, when Route_001 and Route_002 join at Join_01, the branch route of the Route_002 is terminated, and the branch route (main route) of the Route_001 continues. Note that Route_001 is a route that is joined by another route, Route_001 is terminated at the termination of the update flow.

As described above, the update flow database 22 (flow table) starts with the main route (Route_001), and a new branch route (Route_xxx) is generated by the branching point (Branch_xx) when some components are capable of being processed in parallel. On each route, the firmware update processes (UP_UNIT_xxx) for components are set in accordance with the procedure, so that the procedure for the firmware update of the virtual tape library apparatus 1A is indicated. The branch routes each join the route specified by the joining point (Join_xx), and are eventually converged into one route (main route).

Note that in currently-conceivable complex systems, there are not so many constituent components in a wide variety. For this reason, the upper limits may not particularly defined for the number of routes (the number of list structures) to be present in a flow table defined as a database and the number of processing elements to be registered in each route.

As described above, it may be said that in the main route, an execution order for constituent components for which firmware update is executed in series (sequentially) (not executed in parallel), a branching point to a branch route, which defines an execution order of constituent components for which firmware update is capable of being executed in parallel, and a joining point from a branch route are defined. In addition, it can be said that in the branch route, an execution order of the firmware update for constituent components in the branch route and information on which joining point of which route the branch route joins are defined.

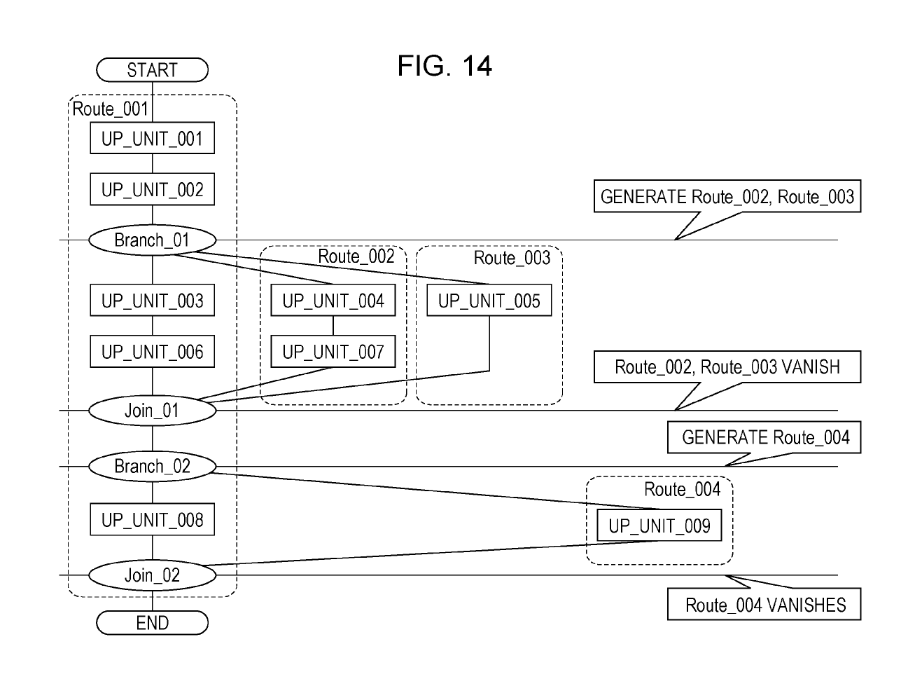

The above-described update flow database 22 (the flow table and the element management table) is formed by defining the update flow illustrated in FIG. 1 as a database. For this reason, it is also possible to restore the update flow from the update flow database 22. Hereinafter, to explain that the update flow database 22 defined based on the update flow is reversible, an example of an approach to generate a firmware update procedure (update flow) based on the update flow database 22 by using the operation console 2A is described with reference to FIG. 14.

The operation console 2A first takes out the list structure of the main route (Route_001) from the flow table. The operation console 2A then takes out processing elements (UP_UNIT_xxx and the like) from the top of the list structure, and generates a flow in the order of the processing elements thus taken out. In the example illustrated in FIG. 14, the operation console 2A generates the flow of UP_UNIT_001, UP_UNIT_002, and so on at the first item, the second item, and so on in Route_001 illustrated in FIG. 7.

When the processing element taken out is a branching point (Branch_xx (Route_xxx, Route_xxx, . . . )), the operation console 2A generates a branch of a route specified by the parameter. In the example illustrated in FIG. 14, the operation console 2A generates branches such as Branch_01, Branch_02, and the like at the third and seventh items in Route_001 in FIG. 7. Thereafter, the operation console 2A also processes the branch route in a similar manner to the main route.

When the processing element taken out is a joining point (Join_xx (Base)), the operation console 2A generates a waiting point for the branch route. In the example illustrated in FIG. 14, the operation console 2A generates waiting points for Join_01, Join_02, and the like at the sixth and ninth items in Route_001 in FIG. 7.

The processing element taken out from the branch route is a joining point (Join_xx (Route_xxx)), the operation console 2A joins the branch route to the waiting at the specified joining point, and terminates the branch route. Note that a processing element (Join_xx (Route_xxx)) serving as the joining point to join another route does not exist in the main route. In the example illustrated in FIG. 14, the branch routes (Route_002, Route_003) join, respectively at the third item in Route_002 and the second item in Route_003 in FIG. 7, the waiting point (Join_01 (Base)) at the sixth item in Route_001. In addition, the branch route (Route_004) joins, at the second item in Route_004 in FIG. 7, the waiting point (Join_02 (Base)) at the ninth item in Route_001. Upon these events, the operation console 2A terminates Route_002 to Route_004.

Once all the processing elements in the list structure are taken out, the update flow is completed. Note that all the routes other than the main route join another route and are terminated. In this way, once the update flow is restored from the update flow database 22 illustrated in FIG. 7, the update flow illustrated in FIG. 14 is established. This update flow coincides with that illustrated in FIG. 1.

The firmware update time estimating unit 23 of the operation console 2A is capable of automatically calculating the estimated time for total firmware update by using the update flow database 22 defined as a database as described above.

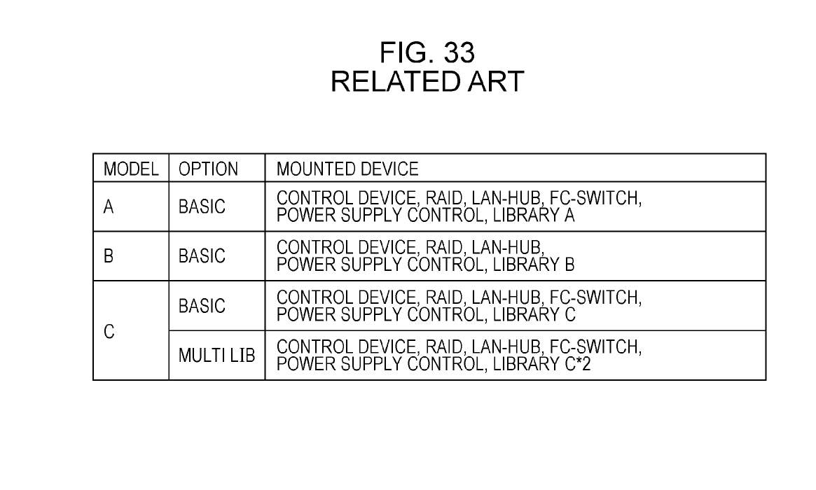

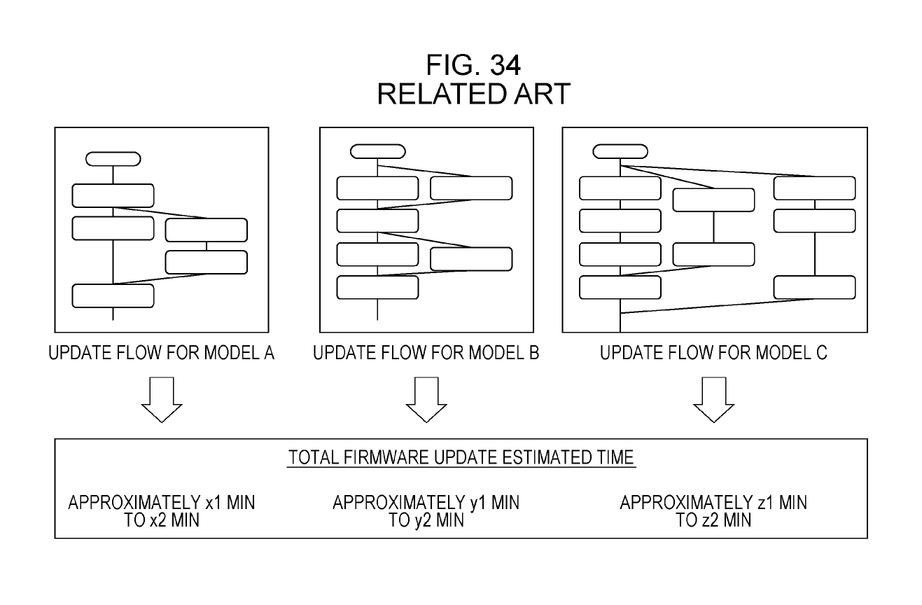

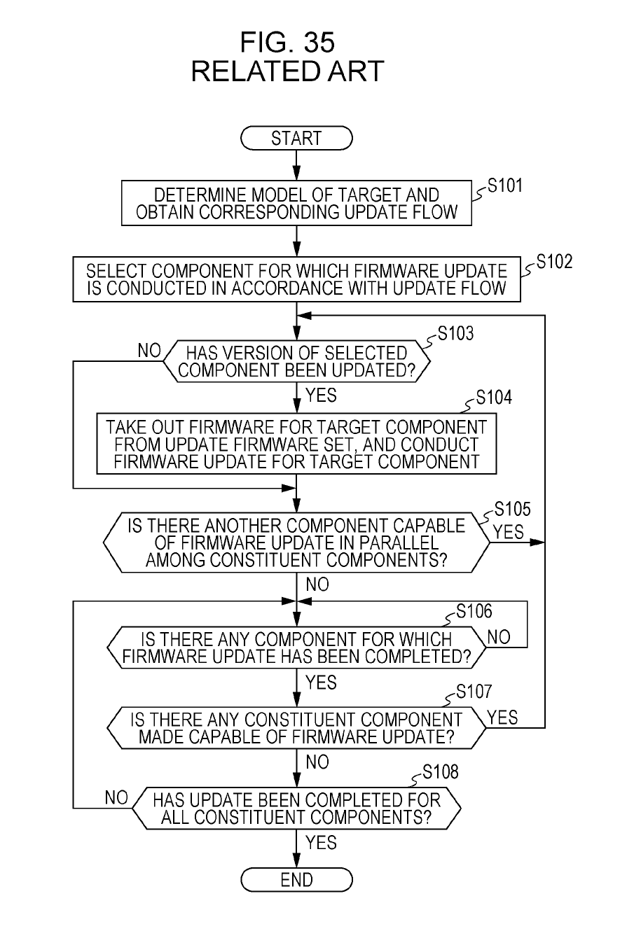

Note that as illustrated in FIGS. 33 and 34, if the model information of the complex system is different, the constituent components of the complex system are different, and the update flow is also different. When a plurality of models exist for a complex system to be the update firmware set 30 is applied, and a plurality of update flows corresponding to the models exist, the same number of the update flow databases 22 as that of the existing update flow are defined and stored on a management server that manages the complex system.

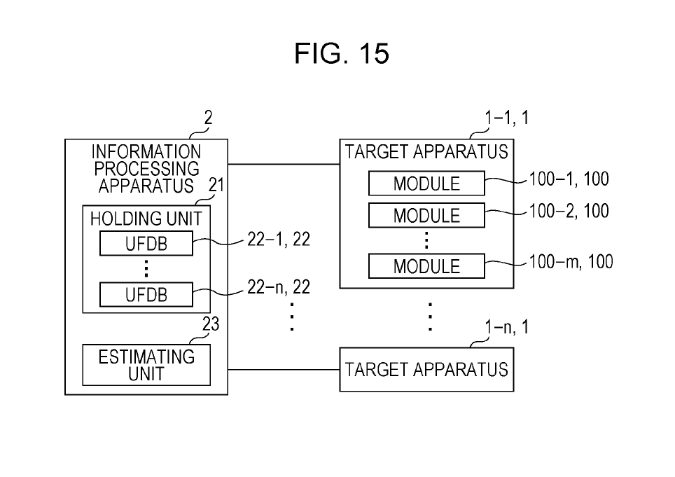

For example, as illustrated in FIG. 15, the information processing apparatus 2 is capable of managing a plurality of target apparatuses 1-1 to 1-n (n is a natural number) alone. The target apparatuses 1-1 to 1-n are different from each other in device configurations such as model/option in FIG. 33, for example. In this case, the holding unit 21 of the information processing apparatus 2 stores update flow databases 22-1 to 22-n corresponding respectively to all the target apparatuses 1-1 to 1-n. Note that in FIG. 15, each update flow database 22 is represented as UFDB 22.

Note that the update flow databases 22-1 to 22-n are associated with model types (device configurations) such as model/option of their corresponding target apparatuses 1-1 to 1-n.

As described above, for a plurality of virtual tape library apparatuses 1A having device configurations different from each other, the holding unit 21 holds information (UFDBs 22) indicating a plurality of execution orders of update processes for the plurality of modules 100A included in the respective virtual tape library apparatus 1A in association with the device configurations.

Description of Firmware Update Time Estimating Unit

Next, back in the description of FIG. 6, the firmware update time estimating unit 23 is described in detail. The firmware update time estimating unit 23 calculates the estimated time for total firmware update for a complex system to be subjected to firmware update.

The firmware update time estimating unit 23 exemplarily includes a DB selecting section 24, a block dividing section 25, an estimated time selecting section 26, a first calculating section 27, and a second calculating section 28.

The DB selecting section 24 performs an update flow database selecting process to select, from the holding unit 21, the update flow database 22 prepared for the model of the virtual tape library apparatus 1A to be subjected to firmware update.

The block dividing section 25 performs a block dividing process to divide the update flow database 22, selected by the DB selecting section 24, into one or a plurality of process blocks by its block dividing function. Here, the process block is a block regarding a plurality of (a series of) component firmware update processes as a single component firmware update process. As described later, the process blocks include a single-route block and a multi-route block. The single-route block is a process block including a single-route component firmware update process in which update processes are performed in series (sequentially), and the multi-route block is a process block including a multi-route component firmware update process in which update processes are performed in parallel.

The estimated time selecting section 26 performs a firmware update time selecting process to assign each component firmware update process (UP_UNIT_xxx) in the update flow database 22 with a firmware update estimated time of an appropriate component, by using its function to select a firmware update estimated time for each constituent component.

The first calculating section 27 performs a block estimated time calculating process to obtain a processing time taken for firmware update for each process block by using a function to calculate a firmware update estimated time for each process block from the firmware update processing time for each component assigned by the estimated time selecting section 26.

The second calculating section 28 adds up estimated times of the respective process blocks obtained by the first calculating section 27 to obtain an estimated time for total firmware update for the model using the update flow.

When performing firmware update of the virtual tape library apparatus 1A as the target apparatus 1, the firmware update processing unit 29 performs the firmware update by sequentially processing the processing elements on the route (Route_xxx) defined in each flow table. The firmware update processing unit 29 allows firmware update to be automatically performed based on the update flow database 22 defined in advance, thus making it possible to perform firmware update more accurately and safely than manual firmware update performed by the operator or the like. Note that the function of the firmware update processing unit 29 may be omitted from the operation console 2A.

Hereinafter, each configuration included in the firmware update time estimating unit 23 is described in detail.

Description of DB Selecting Section 24

As described above, the update flow database 22 may exist for each of model types having different configurations (see FIGS. 15, 33, and 34).

The virtual tape library apparatus 1A is often provided with a function to take out model information by issuing a command from the operation console 2A. Accordingly, using this command may determine what model type the virtual tape library apparatus 1A as the target apparatus 1 is. Note that examples of the model information include model/option, for example, information enabling identification of the model type, such as a model name and a model ID.

The DB selecting section 24 obtains the model type of the virtual tape library apparatus 1A by using this model information obtaining function, and selects the update flow database 22 corresponding to the obtained model type from the holding unit 21.

Note that another approach described below may be employed when there is no command for notifying the virtual tape library apparatus 1A of a model type or the virtual tape library apparatus 1A is in a state of not receiving a command when the operation console 2A issues the command. For example, a configuration definition file defining information on the virtual tape library apparatus 1A as the target apparatus 1 is generated in advance, and the model name of the virtual tape library apparatus 1A is registered in the configuration definition file. This enables the DB selecting section 24 to determine the model information on the virtual tape library apparatus 1A and to select the update flow database 22 corresponding thereto in place of the model information obtaining function.

As described above, the DB selecting section 24 may be said to be an example of an obtaining unit that obtains, from one virtual tape library apparatus 1A, information indicating the device configurations of the virtual tape library apparatus 1A, and obtains, from the holding unit 21, the information (UFDB) 22 indicating the execution order corresponding to the obtained device configurations.

Description of Block Dividing Section 25

The block dividing section 25 divides the update flow database 22 into one or more process blocks in accordance with the following procedure.

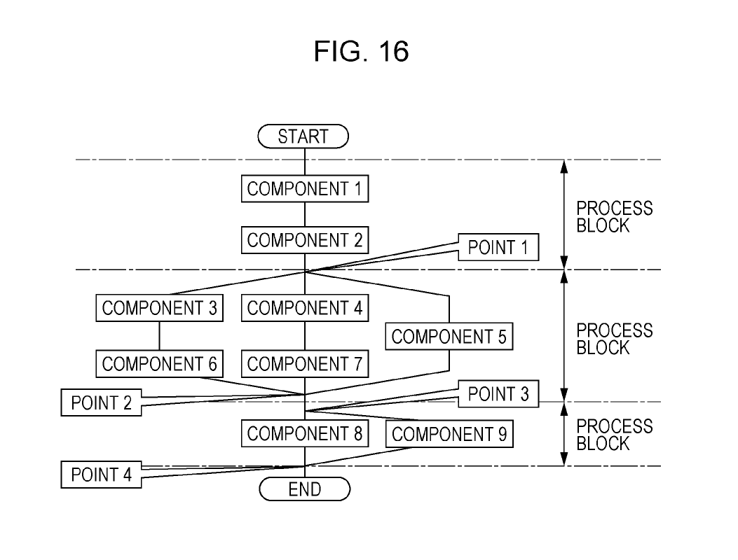

As an example, the block dividing section 25 sequentially reads the list structure of the main route in the update flow database 22 selected by the DB selecting section 24, in accordance with the update order until reaching the branching point (Branch_xx). At this event, the block dividing section 25 determines a series of component firmware update processes (UP_UNIT_xxx) until reaching the branching point as a process block for a single route (a single-route block, an example of a second process block) in which the update processes are performed in series (sequentially). In the example illustrated in FIG. 1 (FIG. 14), the component 1+the component 2 (UP_UNIT_001+UP_UNIT_002) are determined as one single-route block, as illustrated in FIG. 16.

When the block dividing section 25 reaches the branching point, the block dividing section 25 determines a flow part until a joining point where all the routes that have branched at the branching point again join into one route, as a process block for multi-routes (a multi-route block, an example of a first process block) in which the update processes are performed in parallel. In the example illustrated in FIG. 1 (FIG. 14), the component 3+the component 6, the component 4+the component 7, and the component 5 (UP_UNIT_003+UP_UNIT_006, UP_UNIT_004+UP_UNIT_007, and UP_UNIT_005) at point 1 to the point 2 (Branch_01 to Join_01) are determined as one multi-route block, as illustrated in FIG. 16. In addition, as another example illustrated in FIG. 1 (FIG. 14), the component 8+the component 9 (UP_UNIT_008+UP_UNIT_009) at the point 3 to the point 4 (Branch_02 to Join_02) are determined as one multi-route block, as illustrated in FIG. 16.

Note that when a block route that has branched in a multi-route block further branches before joining another route, the block dividing section 25 determines a flow part to a point where all the block routes that have further branched join, as one process block.

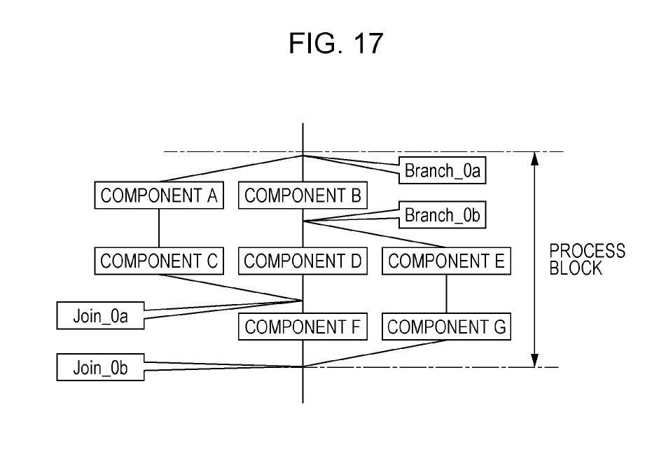

For example, as illustrated in FIG. 17, there is a case where after a route branches into two routes, a component A+component C and a component B, at Branch_0a, the component B further branches into a component D and a component E+component G at Branch_0b before joining the component A+component C. Meanwhile, the component D joins the component A+component C at Join_0a, and the component E+component G joins the component F following the component D at Join_0b. In such a case, the block dividing section 25 determines a flow part from the first branching point (Branch_0a) to the joining point (Join_0b) where all the branch routes join, as one multi-route block.

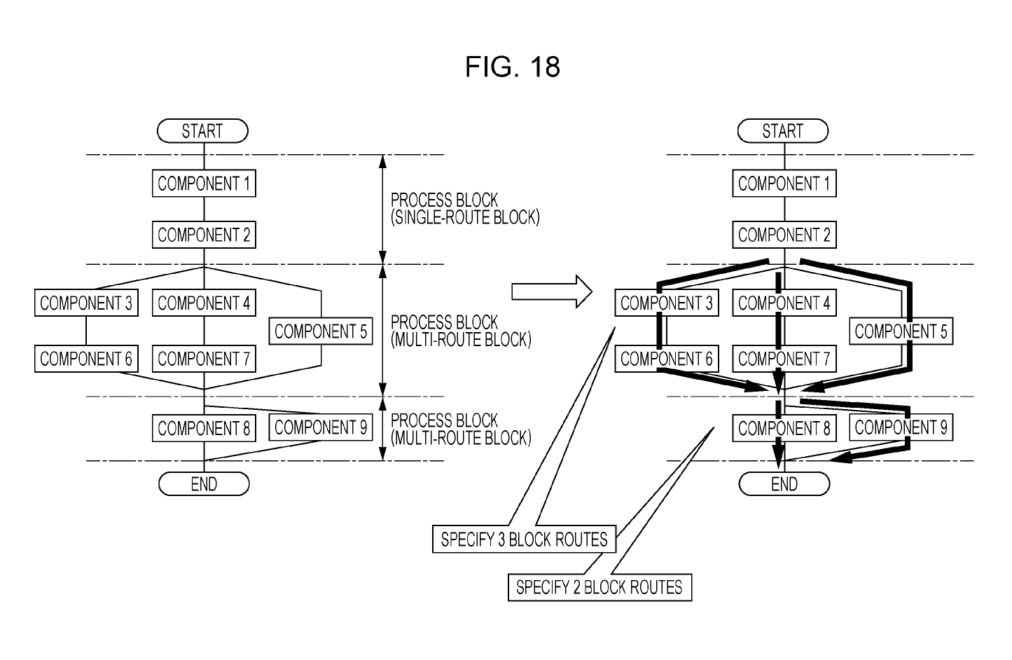

In addition, regarding a process block determined as a multi-route block, the block dividing section 25 defines (specifies) all the routes from the top to the end of the process block, as block routes. In an example illustrated in FIG. 1 (FIG. 14), in the process block from the point 1 to the point 2 (Branch_01 to Join_01), three routes, that is, the route of the component 3+component 6 (Route_001), the route of the component 4+component 7 (Route_002), and the route of the component 5 (Route_003), are defined as block routes, as illustrated in FIG. 18. In another example illustrated in FIG. 1 (FIG. 14), in the process block from the point 3 to the point 4 (Branch_02 to Join_02), two routes, that is, the route of the component 8 (Route_001) and the route of the component 9 (Route_004), are defined as block routes.

Moreover, in a case where a plurality of branching points exist or a plurality of joining points exist because a further branching occurs in a process block, a certain firmware update process (UP_UNIT_xxx) may be included in two block routes or more.

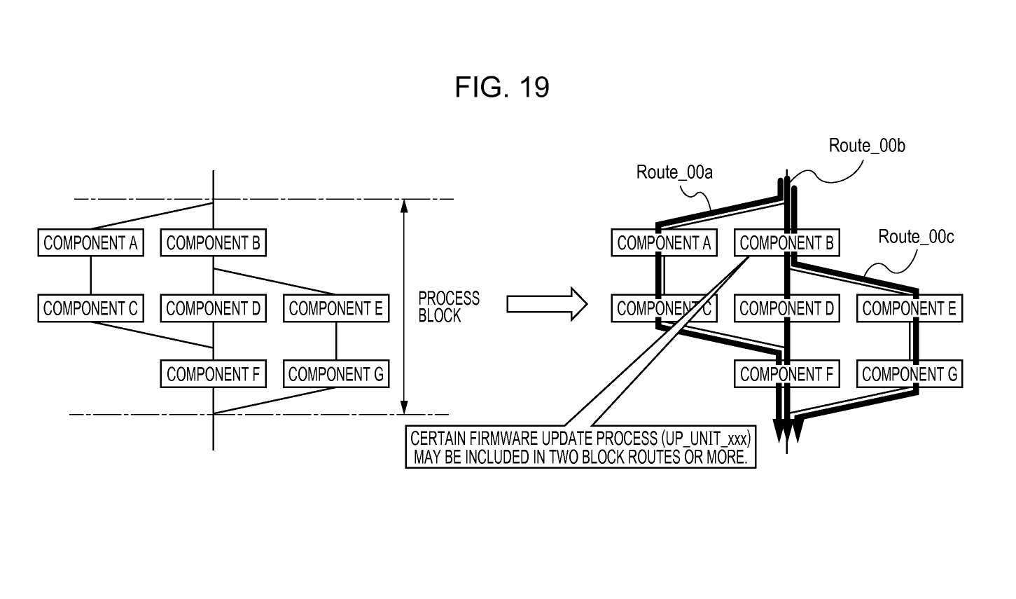

In the example illustrated in FIG. 17, three routes, that is, the route of the component A+component C+component F (at least part of Route_00a), the route of the component B+component D+component F (at least part of Route_00b), and the route of the component B+component E+component G (at least part of Route_00c), are defined as block routes, as illustrated in FIG. 19.

Upon performing block division as described above, the block dividing section 25 may set, in the flow table of the update flow database 22, information that specifies to which process block each processing element belongs. The update flow database 22 processed by the block dividing section 25 is utilized also in subsequent processing of the estimated time selecting section 26 and the first calculating section 27. Note that the block dividing section 25 preferably generates a copy of the update flow database 22 (flow table) and set, in that copy, information on the process blocks obtained by dividing the update flow.

Note that the block dividing section 25 may not perform one or more update processes to be sequentially executed from the plurality of modules 100A (or the update processes thereof) included in the update flow database 22, that is, defining (specifying) of a single-route block (second process block). This is because since the single-route block is such that update processes of the plurality of modules 100A in the process block are performed in series, the result of calculating the estimated time for total firmware update may not be affected even when each of the modules 100A is regarded as an individual process block.

In other words, the block dividing section 25 may only specify at least a multi-route block (first process block) from the plurality of modules 100A (or the update process thereof) included in the update flow database 22. Note that the block dividing section 25 is capable of reducing processing load on the first calculating section 27 and the second calculating section 28 by specifying not only a multi-route block but also a single-route block.

As described above, the block dividing section 25 may be said to be an example of a specification unit that specifies one or more first process blocks from a plurality of update processes (processing elements) based on the information (UFDB) 22 indicating an execution order, each of the first process blocks being a process block formed by combining a plurality of update processes to be executed in parallel.

Description of Estimated Time Selecting Section 26

The update time (firmware update time) taken for firmware update for each component (module 100A) included in the virtual tape library apparatus 1A may vary depending on the function of the firmware to be updated, the performance of a program, and the like. Such variation in firmware update time among the components may cause an error in the estimated time for total firmware update.

In addition, a variety of firmware update systems are used depending on the components. For example, besides a system in which the entire firmware is substituted (overwritten), a differential firmware update system is sometimes used, in which only a different part from the previous version is updated. In the case of the differential firmware update system, the update time taken for the firmware update may vary depending on the currently operating firmware version of a component currently in operation.

Moreover, it is not typically the case where the firmware is updated for all the components (modules 100A) of the virtual tape library apparatus 1A.

Meanwhile, in the firmware management of a complex system, the firmware version of each component is often managed as for a previously released firmware version of the complex system and a new firmware version to be released this time. Specifically, when the firmware of the complex system is updated from a previously released (applied) firmware version to a new firmware version released this time, it is managed as firmware management information which version to which version the firmware version of each component of the complex system is updated.

In view of this, in the system according to the embodiment, the firmware management information is expanded, and a firmware update time database 32 for each constituent component (module 100A) is added to the update firmware set 30 in order to more accurately obtain the estimated time for total firmware update (see FIG. 6).

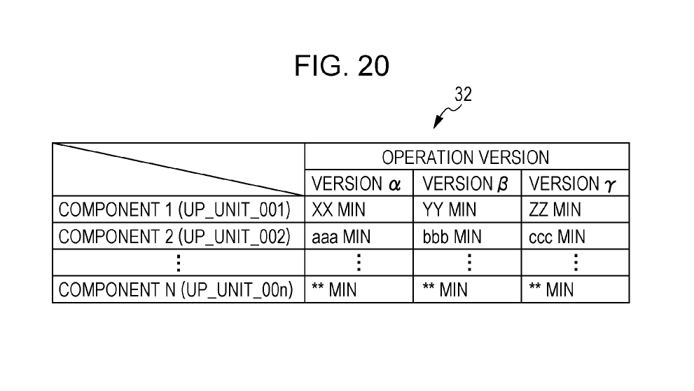

In the firmware update time database 32, as illustrated in FIG. 20, an update time taken for updating the firmware of each component (module 100A) from a current operation version to a version of firmware data 31 included in the update firmware set 30 is set. As one example, as illustrated in FIG. 20, the update time taken for updating the firmware of the component 1 (UP_UNIT_001) is XX minutes in a case where the operating version is a version α, YY minutes in a case where the operating version is a version β, and ZZ minutes in a case where the operating version is a version γ.

The firmware update time database 32 is included in the update firmware set 30 at the time of firmware release (provision of the update firmware set 30) for the virtual tape library apparatus 1A as the target apparatus 1.

The estimated time selecting section 26 obtains a current operation version from the virtual tape library apparatus 1A as the target apparatus 1 by using a predetermined command. The estimated time selecting section 26 then reads the firmware update time database 32 from the holding unit 21, and applies (sets) the update time for each component corresponding to the operating version of the virtual tape library apparatus 1A to (in) the update flow database 22 processed by the block dividing section 25. This allows the first calculating section 27 and the second calculating section 28 to more accurately obtain the estimated time for total firmware update in a case where the provided update firmware set 30 is applied to the model of the virtual tape library apparatus 1A.

Description of First Calculating Section 27

The first calculating section 27 calculates an update time taken for firmware update for each process block divided by the block dividing section 25.

For example, the first calculating section 27 refers to the update flow database 22, and calculates, for each process block set by the block dividing section 25, a total update time for the process block by using the update time for each module 100A in the process block.

As one example, in a single-route block, the modules 100A in the process block are updated in series (sequentially one by one). Thus, for the single-route block, the first calculating section 27 may only calculate a total of update times of the respective modules 100A in the process block.

On the other hand, in a multi-route block, the modules 100A in the process block are updated in parallel. Thus, in the case of the update time for a multi-route block, the block route in which update times for the respective block routes defined in the process block have the largest value (the block route having the largest total time for firmware update) is used for the update time for the process block. In view of this, the first calculating section 27 may only calculate, for each block route of the multi-route block, a total of update times for the respective modules 100A included in the block route, and set the largest total time as the update time for the multi-route block.

The first calculating section 27 sets the update time for each process block calculated as described above in the update flow database 22. For example, since the block dividing section 25 has set information on the process blocks in the flow table of the update flow database 22, the first calculating section 27 may additionally write an update time for each process block in the information.

As described above, the estimated time selecting section 26 and the first calculating section 27 may be said to be an example of a first estimating unit that calculates an update time for each multi-route block specified by the block dividing section 25, by using information (firmware update time DB) 32 indicating an update time taken for each of a plurality of update processes (processing elements).

In addition, the estimated time selecting section 26 and the first calculating section 27 estimate update times for the respective routes in which update processes are executed in parallel in a multi-route block specified by the block dividing section 25, and sets the longest update time among the update times estimated for the respective routes as an update time for the multi-route block. In this way, even when the update processes branch in a multi-route block, the estimated time selecting section 26 and the first calculating section 27 are capable of accurately calculating a firmware update estimated time for the multi-route block.

Description of Second Calculating Section 28

The second calculating section 28 calculates an estimated time for total firmware update for the virtual tape library apparatus 1A as the target apparatus 1, based on update times for the respective process blocks calculated by the first calculating section 27.

As described above, the update time of each of the process blocks (single-route blocks and multi-route blocks) has been calculated by the first calculating section 27. Thus, the second calculating section 28 is capable of calculating the firmware update time for the entire virtual tape library apparatus 1A by adding up these update times.

As described above, the second calculating section 28 may be said to be an example of a second estimating unit that estimates the update time of the virtual tape library apparatus 1A, based on at least one of information (firmware update time DB) 32, which indicates the update time, and the update time for each first process block, which is estimated by the estimated time selecting section 26 and the first calculating section 27. For example, the second calculating section 28 adds up the update time for each multi-route block and the update time for each single-route block, which is estimated by the estimated time selecting section 26 and the first calculating section 27. This makes it possible to accurately estimate the update time for the virtual tape library apparatus 1A.

The operation console 2A outputs the estimated time for total firmware update estimated as described above to the operator. The outputting may be achieved by any of various known techniques including display on an output device such as a monitor, storage in a file, and transmission of an e-mail.

As described above, the system according to the embodiment (the information processing apparatus 2) is capable of automating the calculation of the estimated time for total firmware update for the target apparatus 1 by using the update flow defined as a database. This makes it possible to reduce the load on the operator in charge of firmware update, and to accurately and safely derive time (estimated time for total firmware update) taken for the firmware update for the target apparatus 1 (the complex system).

As described above, it is conceivable that the estimated time for total firmware update is obtained by the operator in charge of the firmware update, referring to the update flow and performing theoretical simulation.

By contrast, in the system according to the embodiment, the information processing apparatus 2 manages, for each model (configuration), the database 22 for the update flow in which routes to conduct firmware update are set. By using the database 22, the information processing apparatus 2 is capable of dividing, as process blocks, the modules 100A capable of being processed in parallel in the firmware update for the target apparatus 1. Therefore, the information processing apparatus 2 is capable of easily calculating the estimated time for total firmware update by taking the parallel processing of firmware update into consideration even when the target apparatus 1 has a complicated update flow.

In addition, the function as the information processing apparatus 2 may be integrated in, for example, a management server that manages the virtual tape library apparatus 1A as the target apparatus 1, as illustrated in FIG. 5. The virtual tape library apparatus 1A (complex system) to be managed is controlled by the management server via an interface with the management server, and the estimated time for total firmware update is calculated. Therefore, an instruction from the management server, processing in the complex system, a response from the complex system to the management server, and the like, which are involved in the processing in the firmware update time estimating unit 23, may be executed by using an existing interface. This makes it possible to achieve the above-described function only by setting a predetermined program (update time estimating program) in the information processing apparatus 2, and thus to suppress an increase in costs.

### Operation Example

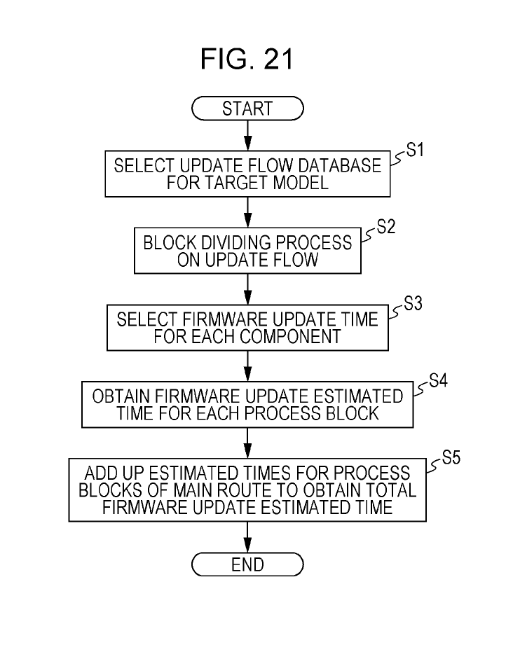

Next, an operation example of the information processing apparatus 2 (operation console 2A) of the system configured as described above is described with reference to FIGS. 21 to 25.

First, with reference to FIG. 21, an overall process (update time estimating process) by the firmware update time estimating unit 23 is described.

First, the DB selecting section 24 selects the update flow database 22 for a target model (the virtual tape library apparatus 1A) of firmware update (Step S1).

Next, the block dividing section 25 divides the update flow database 22 into one or more process blocks (Step S2).

Next, the estimated time selecting section 26 selects the firmware update time for each component in the update flow database 22 from the firmware update time database 32, and sets the selected firmware update time in the update flow database 22 (Step S3).

Then, the first calculating section 27 obtains the firmware update estimated time for each process block (Step S4).

Lastly, the second calculating section 28 adds up the estimated times of the process blocks (process blocks determined by the first calculating section 27) in the main route to obtain an estimated time for total firmware update (Step S5), so that the processing thus ends.

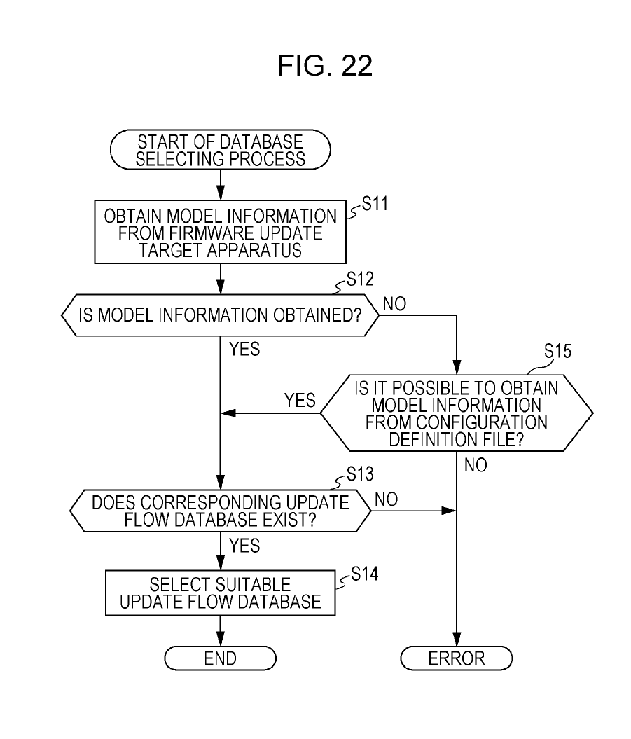

Next, with reference to FIG. 22, the DB selecting process conducted by the DB selecting section 24 (Step S1 in FIG. 21) is described.

The DB selecting section 24 issues an obtaining command for apparatus model information to the virtual tape library apparatus 1A, which is the target apparatus 1 for firmware update to obtain the model information (Step S11).

When the DB selecting section 24 obtains the model information by using the obtaining command (Step S12, Yes route in Step S12), the DB selecting section 24 determines whether or not the corresponding update flow database 22 is held in the holding unit 21 (Step S13). When the update flow database 22 is held (Yes route in Step S13), the DB selecting section 24 selects a suitable update flow database 22 (Step S14), so that the processing thus ends.

On the other hand, when the corresponding update flow database 22 is not held in the holding unit 21 in Step S13 (No route in Step S13), the processing ends as an error because of database selection failure.

Meanwhile, when the DB selecting section 24 does not obtain the model information by using the obtaining command in Step S12 (No route in Step S12), the DB selecting section 24 determines whether or not the model information is capable of being obtained from the configuration definition file (Step S15). When the model information is capable of being obtained from the configuration definition file (Yes route in Step S15), the processing proceeds to Step S13.

On the other hand, when the model information is not obtained from the configuration definition file in Step S15 (No route in Step S15), the processing ends as an error due to database selection failure because there is no configuration definition file or the model information of the target apparatus 1 is not registered in the configuration definition file.

The DB selecting section 24 determines the update flow database 22 selected by the above processing as the update flow database 22 for the target apparatus 1.

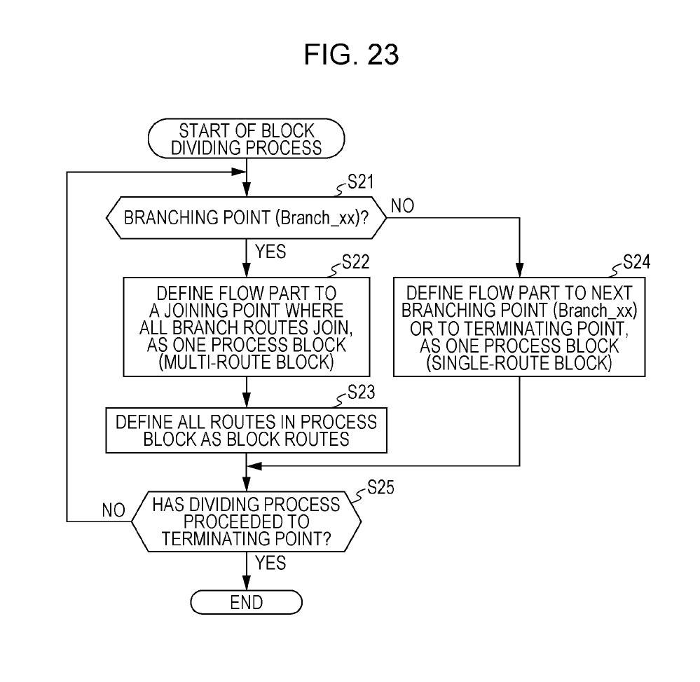

Next, with reference to FIG. 23, the block dividing process conducted by the block dividing section 25 (Step S2 in FIG. 21) is described. Note that it is assumed that the block dividing section 25 reads the list structures of the main route sequentially from the flow table of the update flow database 22 selected by the DB selecting section 24.

First, the block dividing section 25 determines whether or not the current position on the route is at the branching point (Branch_xx) in the flow table (Step S21). When the current position on the route is at the branching point (Branch_xx) (Yes route in Step S21), the block dividing section 25 defines a flow part to the joining point where all the routes that have branched join again into one route, as one process block (Step S22). Note that this process block is a multi-route block.

Note that a block route that has branched further branches before joining again another route, the block dividing section 25 determines a flow part to a point where all the block route that have further branched join, as one process block.

Next, the block dividing section 25 defines all the routes between the top to the end of the process block defined as the multi-route block, as block routes (Step S23). The processing then proceeds to Step S25.

On the other hand, the current position on the route is not the branching point (Branch_xx) in Step S21 (No route in Step S21), the block dividing section 25 defines a flow part to the next existing branching point or to a terminating point, as one process block (Step S24). The processing then proceeds to Step S25. Note that this process block is a single-route block.

In Step S25, the block dividing section 25 determines whether or not the dividing process has proceeded to the terminating point (the last line in the list structures of the main route). When the dividing process has been processed to the terminating point (Yes route in Step S25), the processing is terminated.

On the other hand, when the dividing process has not been processed to the terminating point (No route in Step S25), the processing proceeds to Step S21.

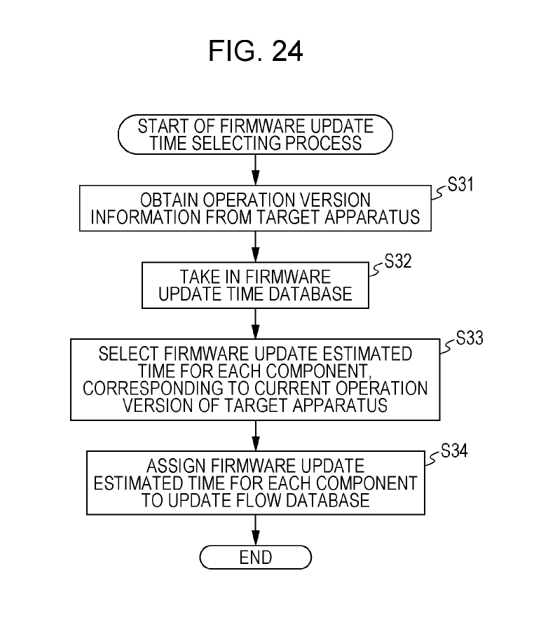

Next, with reference to FIG. 24, the firmware update time selecting process conducted by the estimated time selecting section 26 (Step S3 in FIG. 21) is described.

The estimated time selecting section 26 obtains the current operation version information from the virtual tape library apparatus 1A as the target apparatus 1 for the firmware update by issuing a predetermined command (Step S31). Note that the obtaining of the version information may also be conducted at a similar timing to the obtaining of the model information of the virtual tape library apparatus 1A conducted by the DB selecting section 24.

Next, the estimated time selecting section 26 takes in the firmware update time database 32 added to the update firmware set 30 (Step S32). Note that the estimated time selecting section 26 may obtain the firmware update time database 32 from the holding unit 21 when the operation console 2A has held information on the update firmware set 30 in the holding unit 21 in advance.

In addition, the estimated time selecting section 26 extracts, from the firmware update time database 32, a firmware update time for each component, corresponding to the operation version of the virtual tape library apparatus 1A obtained in Step S31 (Step S33).

The estimated time selecting section 26 then assigns the firmware update time for each component, which is extracted in Step S33, to the update flow database 22 (Step S34), and the processing is terminated.

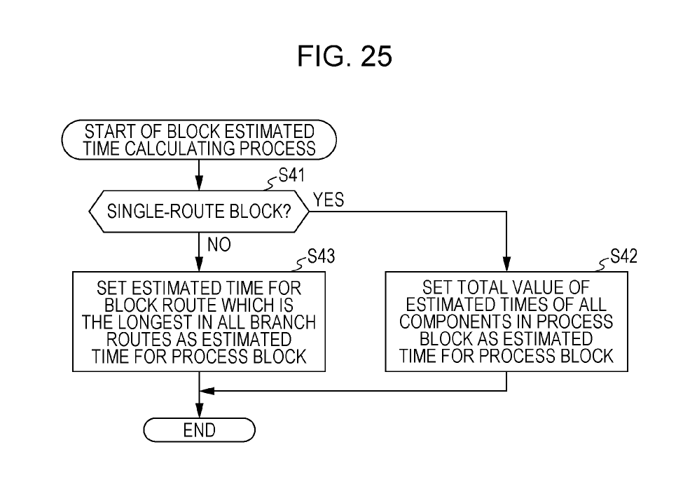

Next, with reference to FIG. 25, the block estimated time calculating process conducted by the first calculating section 27 (Step S4 in FIG. 21) is described. Note that, the processing in FIG. 25 is repeatedly executed for the number of process blocks specified by the block dividing section 25.

First, the first calculating section 27 determines whether or not the process block for which to obtain an estimated time is a single-route block (only one block route exists in the process block) (Step S41). When the process block is a single-route block (Yes route in Step S41), the first calculating section 27 adds up all the firmware update times for components included in the process block, sets the resultant total value as the estimated time for the process block (Step S42), and terminates the calculation of the block estimated time for the process block.

On the other hand, when the process block is not a single-route block (No route in Step S41), the first calculating section 27 determines that the process block is a multi-route block, and obtains the estimated times for all the block routes included in the process block in the same manner as in Step S42. The first calculating section 27 then sets the estimated time for the block route that has the largest total value in all the block routes for which the estimated times are obtained, as the estimated time for the process block (Step S43), and terminates the calculation of the block estimated time for the process block.

### EXAMPLE

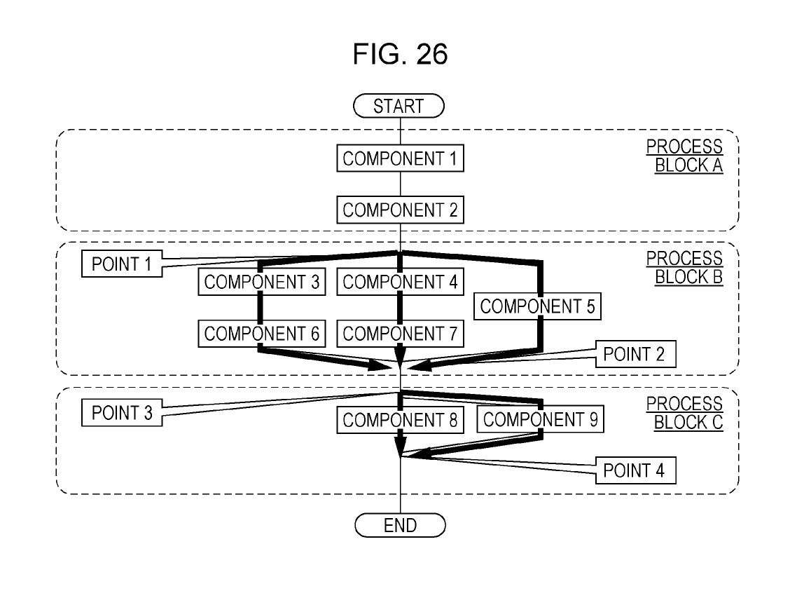

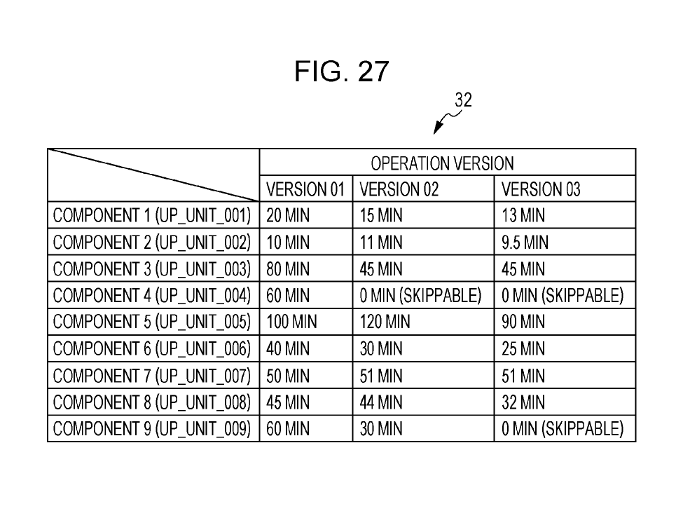

Next, an example of the system according to the embodiment configured as described above is described. Note that it is assumed that the virtual tape library apparatus 1A as one example of the target apparatus 1 includes 9 components, that is, the component 1 to the component 9, and has the update flow illustrated in FIG. 26, and also the firmware update time database 32 is one illustrated in FIG. 27.

### First Example

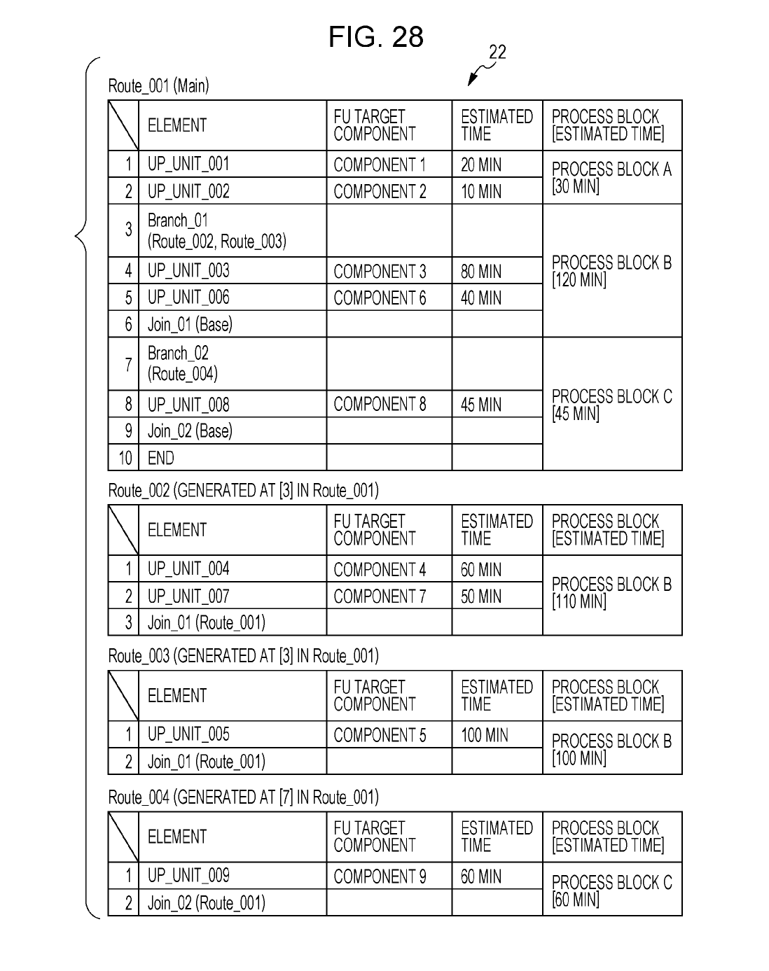

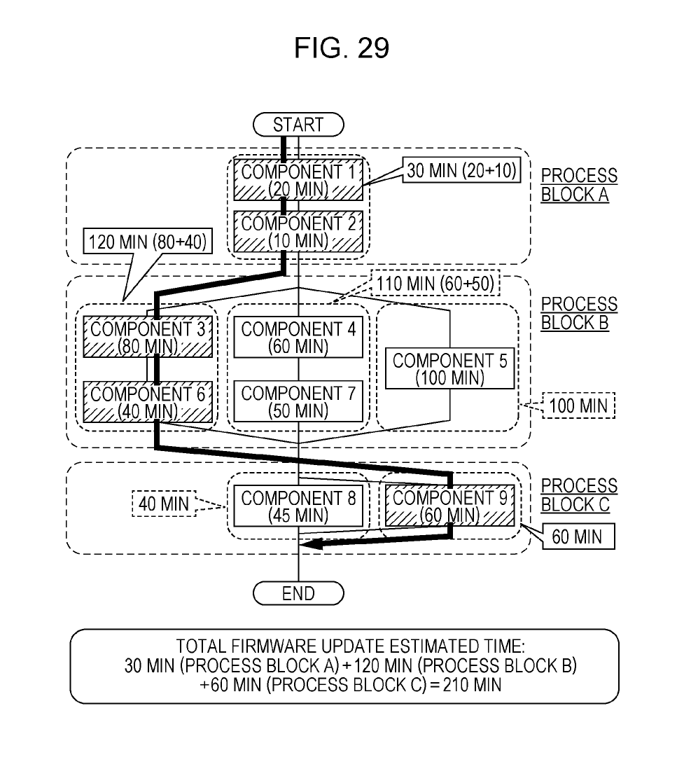

FIG. 28 is a diagram illustrating a flow table of an update flow database according to the first example. FIG. 29 is a diagram illustrating a result of calculation of an estimated time for total firmware update according to the first example. First, with reference to FIG. 28 and FIG. 29, a case of updating the firmware of the virtual tape library apparatus 1A from a version 01 to the latest version of an update firmware set 30 is described.

In the case of the update flow illustrated in FIG. 26, the update flow database 22 (flow table) for updating the firmware from the version 01, which is the current operation version, to a released version in accordance with the firmware update time database 32 illustrated in FIG. 27 is as illustrated in FIG. 28.

Specifically, as illustrated in FIG. 28, the block dividing section 25 sets process block information (indicated as “process blocks” in FIG. 28) obtained by dividing the update flow in the flow table of the basic update flow database 22 illustrated in FIG. 7. In addition, the estimated time selecting section 26 sets firmware update time information (indicated as “estimated times” in FIG. 28) for each selected component in the flow table. Moreover, the first calculating section 27 sets estimated time (indicated as process block “[estimated time]” in FIG. 28) for each process block in the process block information in the flow table.

As illustrated in FIG. 28, the block dividing section 25 divides the update flow for the virtual tape library apparatus 1A into three process blocks, that is, a process block A, a process block B, and a process block C.

As illustrated in FIG. 29, since the process block A is a single-route block, the first calculating section 27 obtains 20 minutes+10 minutes=30 minutes as a total time by adding up the firmware update times for the component 1 and the component 2.

The process block B is a multi-route block. The block route in which the firmware update for the component 3 and the component 6 is conducted is 80 minutes+40 minutes=120 minutes. The block route in which the firmware update for the component 4 and the component 7 is conducted is 60 minutes+50 minutes=110 minutes. The block route in which the firmware update for the component 5 is conducted is 100 minutes. The first calculating section 27 calculates these times, and sets the largest value, which is 120 minutes of the block route in which the firmware update for the component 3 and the component 6 is conducted, as the estimated time for the process block B.

Similarly, the process block C is a multi-route block, and the first calculating section 27 sets 60 minutes taken for the block route for the component 9 as the estimated time for the process block C.

In this way, the estimated time selecting section 26 and the first calculating section 27 calculate (determine) 30 minutes of the Route_001 in the process block A, 120 minutes of the Route_001 in the process block B, and 60 minutes of the Route_004 in the process block C as (the longest) estimated times for the respective process blocks.

The second calculating section 28 adds up the estimated times for all the process blocks to thus obtain 210 minutes (30 minutes+120 minutes+60 minutes).

As described above, in the first example, the estimated time for total firmware update, which is taken for the firmware update from the currently operating version 01 to the released version is derived as 210 minutes.

### Second Example

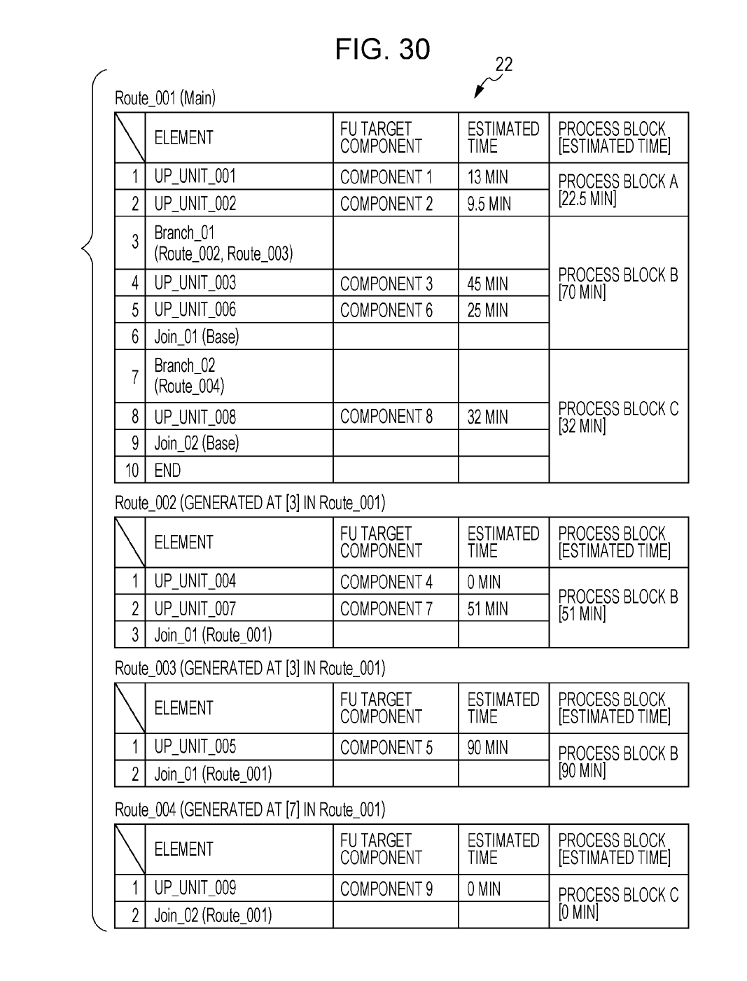

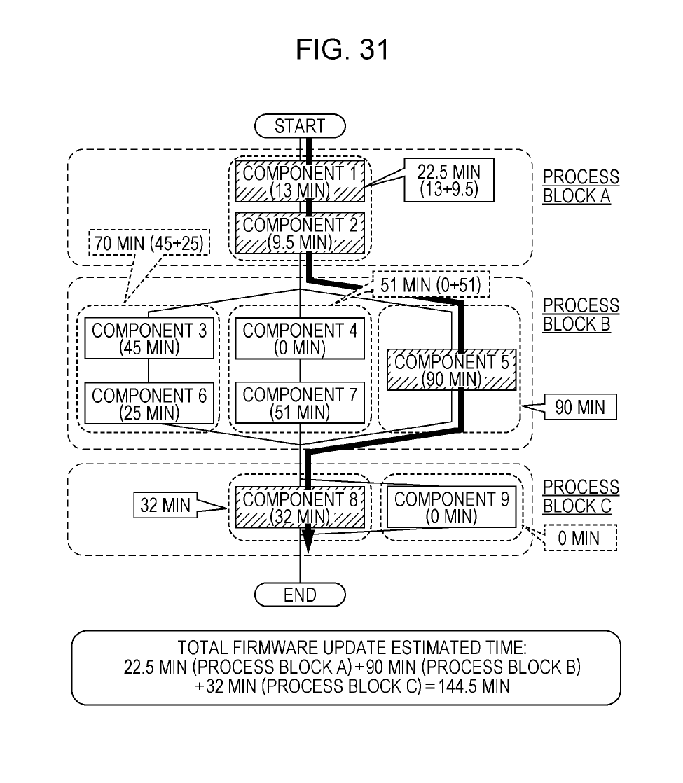

Next, with reference to FIGS. 30 and 31, the case of updating the firmware of the virtual tape library apparatus 1A from the version 03 to the latest version of the update firmware set 30 is described.

Like the first example, in the case of the update flow illustrated in FIG. 26, the update flow database 22 (flow table) for updating the firmware from the version 03, which is the current operation version, to a released version in accordance with the firmware update time database 32 illustrated in FIG. 27 is as illustrated in FIG. 30.

As illustrated in FIG. 27, when the current operation version is the version 03, the firmware update time for the component 4 and the component 9 is 0 minutes, that is, the firmware update is skippable. In addition, the firmware update times for the component 1 to the component 3, the component 5, the component 6, and the component 8 are also shorter than those when the current operation version is the version 01.

In this case, as illustrated in FIG. 31, for the process block A, the first calculating section 27 obtains 13 minutes+9.5 minutes=22.5 minutes as a total time by adding up the firmware update times for the component 1 and the component 2.

For the process block B, the block route in which the firmware update for the component 3 and the component 6 is conducted is 45 minutes+25 minutes=70 minutes, the block route in which the firmware update for the component 4 and the component 7 is conducted is 0 minutes+51 minutes=51 minutes, the block route in which the firmware update for the component 5 is conducted is 90 minutes. The first calculating section 27 calculates these times, and determines the largest value, which is 90 minutes of the block route in which the firmware update for the component 5 is conducted, as the estimated time for the process block B.

Similarly, for the process block C, the first calculating section 27 determines 32 minutes taken for the block route for the component 8 as the estimated time for the process block C.

In this way, the estimated time selecting section 26 and the first calculating section 27 calculate (determine) 22.5 minutes of the Route_001 in the process block A, 90 minutes of the Route_003 in the process block B, and 32 minutes of the Route_001 in the process block C as (the longest) estimated times for the respective process blocks.

The second calculating section 28 adds up the estimated times for all the process blocks to thus obtain 144.5 minutes (22.5 minutes+90 minutes+32 minutes).

As described above, in the second example, the estimated time for total firmware update, which is taken for the firmware update from the currently operating version 03 to the released version is derived as 144.5 minutes.

As described so far, the operation console 2A according to the embodiment takes in the firmware update time database 32 added to the update firmware set 30 by using the update flow defined as a database in the apparatus firmware update for the virtual tape library apparatus 1A. In this way, the operation console 2A is capable of automatically obtaining an accurate estimated time for total firmware update to apply the update firmware set 30 to the virtual tape library apparatus 1A. For this reason, the operator is capable of planning the firmware update schedule for the target apparatus 1 with an efficient time zone, and also capable of suppressing a reduction in the availability of the target apparatus 1, which is caused by the firmware update.

In addition, since theoretical simulation which is manually conducted before executing firmware update may not be conducted, it is possible to plan the firmware update schedule for target apparatus 1 with a shorter time.

### Hardware Configuration Example

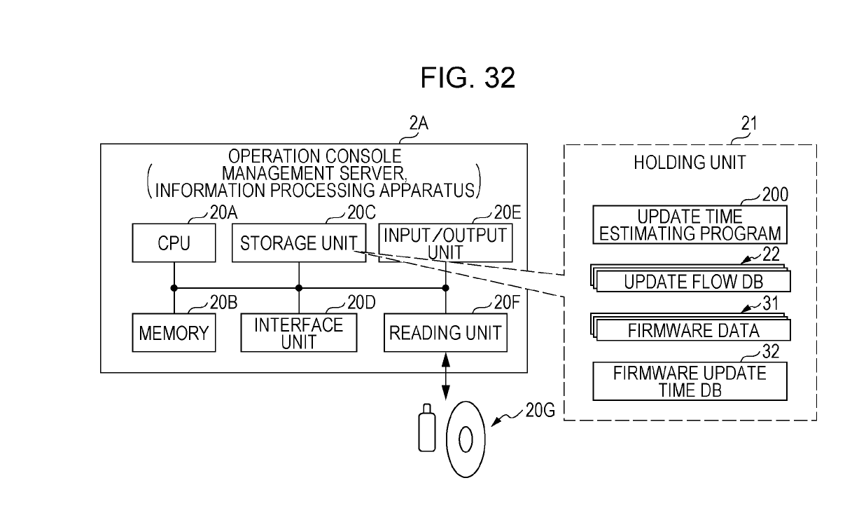

As illustrated in FIG. 32, the operation console 2A (information processing apparatus 2) according to the embodiment described above may include a CPU 20A, a memory 20B, a storage unit 20C, an interface unit 20D, an input/output unit 20E, and a reading unit 20F.

The CPU 20A is an example of an arithmetic processing device (a processor) that performs various controls and operations. The CPU 20A is coupled to the corresponding blocks 20B to 20F, and is capable of achieving various functions executing programs stored in the memory 20B, the storage unit 20C, the recording medium 20G, or a not-illustrated read only memory (ROM) or the like.

The memory 20B is a storage device that stores various types of data and programs. When executing programs, the CPU 20A stores and extracts data and programs in the memory 20B. Note that the memory 20B may be a volatile memory such as a random access memory (RAM).

The storage unit 20C is hardware that stores various types of data, programs, and the like. The storage unit 20C may be any of various devices including magnetic disk devices such as a HDD, semiconductor drive devices such as an SSD, and non-volatile memories such as a flash memory and a ROM. Note that the holding unit 21 illustrated in FIG. 6 may be achieved by the memory 20B or the storage unit 20C.

For example, the storage unit 20C may store an update time estimating program 200 that achieves all or part of the various functions of the operation console 2A, as well as, one or more update flow databases 22. In addition, the storage unit 20C may store a plurality of pieces of firmware data 31 and the firmware update time database 32 included in the provided update firmware set 30.

The interface unit 20D is a communication interface that wiredly or wirelessly performs control on coupling and communications with the virtual tape library apparatus 1A as the target apparatus 1, a network, and another information processing apparatus, and the like. The interface unit 20D may be an adaptor that complies with a LAN, an FC, an Infiniband, or the like. For example, the CPU 20A may store, in the storage unit 20C, a terminal program 200 acquired from a network through the interface unit 20D.

The input/output unit 20E may include at least one of an input device (operating unit), such as a mouse, a keyboard, a touch panel, a microphone for voice operation, as well as, an output device (output unit, display unit) such as a display, a speaker, and a printer. For example, the input device may be used by the operator in charge of the firmware update, an administrator of the virtual tape library apparatus 1A, or the like to perform works including various operations of the operation console 2A and input of data. The output device may be used to output a result of calculation of the estimated time for total firmware update and various notifications.

The reading unit 20F is a device that reads data and programs recorded in a computer-readable recording medium 20G. The terminal program 200 may be stored in the recording medium 20G.

For example, the CPU 20A is capable of achieving the functions of the firmware update time estimating unit 23 (and the firmware update processing unit 29) of the operation console 2A by extracting and executing, in a storage device such as the memory 20B, the terminal program 200 stored in the storage unit 20C.

Note that the recording medium 20G may be an optical disk such as a flexible disk, a compact disc (CD), a digital versatile disc (DVD), and a Blu-ray Disc, or a flash memory such as a Universal Serial Bus (USB) memory and a SD card. Note that the CD may be a CD-ROM, a CD-R (CD-Recordable), a CD-RW (CD-Rewritable), or the like. In addition, the DVD may be a DVD-ROM, a DVD-RAM, a DVD-R, a DVD-RW, a DVD+R, a DVD+RW, or the like.

The above-described blocks 20A to 20F are coupled with one another through buses to be capable of communicating with one another. In addition, the above-described hardware configuration of the operation console 2A is exemplary, and increase or decrease in hardware (for example, addition or omission of any block), division, integration of any combination, addition or omission of a bus, and the like in the operation console 2A may be performed as appropriate.

A preferred embodiment has been described in detail so far, the embodiment is not limiting and may be executed with various modifications and changes within the scope of the gist.

For example, the functional blocks of the operation console 2A illustrated in FIG. 6 may be integrated with any combination, or may be divided.

In addition, the current operation version in the firmware update time database 32 has been described as a version of firmware for the entire virtual tape library apparatus 1A in the above description, the current operation version is not limited to this. For example, the current operation version may be an operation version of the firmware for each component (module 100A). In this case, rows of current operation version to be referred by the firmware update time database 32 may be different for the components.

Moreover, the update flow of the virtual tape library apparatus 1A is basically determined in accordance with model types (device configurations) or the like. For this reason, the update flow database 22 containing information on process blocks and information on block routes defined in the block dividing process may not be frequently updated.

In other words, the update flow database 22 and the update flow database 22 containing the process block information generated from the update flow by the block dividing section 25 may be regularly held by the operation console 2A. This is because the configuration of the virtual tape library apparatus 1A coupled to the operation console 2A is basically fixed.

Note that the procedure for firmware update itself is sometimes changed in conjunction with the firmware update for the virtual tape library apparatus 1A. In this case, since the update flow is changed, the operation console 2A is provided with an updated update flow together with the update firmware set 30 by a developer such as a vendor, and the database 22 in the operation console 2A is thus updated. In this case, in the operation console 2A, the DB selecting process by the DB selecting section 24 and the block dividing process by the block dividing section 25 are executed again to regenerate process block information and block route information.

On the other hand, regarding the firmware update time database 32, the latest database 32 is provided by being included in the update firmware set 30 for every firmware release for the virtual tape library apparatus 1A. Thus, the firmware update time database 32 is preferably updated every time when the operation console 2A receives the update firmware set 30.

Because of these, the processes of the DB selecting section 24 and the block dividing section 25 (the processes of Steps S1 and S2 in FIG. 21, as well as, the processes in FIGS. 22 and 23) may be executed only when the list of update flow for the virtual tape library apparatus 1A is updated. On the other hand, the processes of the estimated time selecting section 26, the first calculating section 27, and the second calculating section 28 (the processes of Steps S3 to S5 in FIG. 21, as well as, the processes in FIGS. 24 and 25) are preferably executed every time when the update firmware set 30 is received (every time when the firmware update process is executed).

As described above, when a new firmware is released, the virtual tape library apparatus 1A obtains the estimated time for total firmware update through the use of the firmware update time estimating unit 23 by using the firmware update time database 32 included in the update firmware set 30.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus for managing a target apparatus including a plurality of modules for which a plurality of update processes of software are executed, the information processing apparatus, comprising:
a specification unit to specify one or more first process blocks from among the update processes for the modules of the target apparatus based on execution order information indicating an execution order of the update processes for the modules of the target apparatus, each first process block including a plurality of update processes to be executed in parallel,
a first estimating unit to estimate an update time for each specified first process block, using update time information indicating an update time taken for each of the update processes for the modules of the target apparatus, and
a second estimating unit to estimate a total update time for the target apparatus, using the update time information and the estimated update time for each specified first process block.

2. The information processing apparatus according to claim 1, wherein
the first estimating unit:
estimates an update time for each of routes in which the plurality of update processes are executed in parallel in each specified first process block, using the update time information, and
sets a longest update time among update times estimated for the respective routes in each specified first process block as an update time for each specified first process block.

3. The information processing apparatus according to claim 2, wherein:
the specification unit specifies one or more second process blocks from among the update processes for the modules of the target apparatus based on the execution order information, each second process block including one or more update processes to be executed sequentially,
the first estimating unit:
estimates an update time for each specified second process block, using the update time information, and
sets the estimated update time as an update time for each specified second process block, and
the second estimating unit estimates a total update time for the target apparatus by adding the update time for each specified first process block and the update time for each specified second process block.

4. The information processing apparatus according to claim 1, wherein:
the target apparatus is one of a plurality of target apparatuses having different apparatus configurations from each other, and
the information processing apparatus further comprises:
a holding unit holds the execution order information corresponding to each apparatus configuration, and
an obtaining unit:
obtains, from one of the target apparatuses, information indicating an apparatus configuration of the one of the target apparatuses, and
obtains, from the holding unit, the execution order information corresponding to the obtained apparatus configuration of the one of the target apparatuses.

5. The information processing apparatus according to claim 4, wherein:
the update time information includes an update time corresponding to each of versions of software before update, and
the first estimating unit:
obtains, from one of the target apparatuses, information indicating a version of software before update for the one of the target apparatuses,
extracts, from the update time information, an update time corresponding to the obtained version of software of the one of the target apparatuses, and
estimates an update time for each specified first process block and an update time for each specified second process block, using the extracted update time.

6. An update time estimating method in an information processing apparatus that manages a target apparatus including a plurality of modules for which a plurality of update processes of software are executed, the information processing apparatus including a storage device to store update time information indicating an update time taken for each of the update processes for the modules of the target apparatus and execution order information indicating an execution order of the update processes for the modules of the target apparatus, the method comprising:
specifying, by a computer, one or more first process blocks from among the update processes for the modules of the target apparatus based on the execution order information, each first process block including a plurality of update processes to be executed in parallel,
estimating, by the computer, an update time for each specified first process block, using the update time information, and
estimating, by the computer, a total update time for the target apparatus, using the update time information and the estimated update time for each specified first process block.

7. The update time estimating method according to claim 6, further comprising:
estimating, by the computer, an update time for each of routes in which the plurality of update processes are executed in parallel in each specified first process block using the update time information, and
setting, by the computer, a longest update time among update times estimated for the respective routes in each specified first process block as an update time for each specified first process block.

8. The update time estimating method according to claim 7, further comprising:
specifying, by the computer, one or more second process blocks from among the update processes for the modules of the target apparatus based on the execution order information, each second process block including one or more update processes to be executed sequentially,
estimating, by the computer, an update time for each specified second process block, using the update time information, and
setting, by the computer, the estimated update time as an update time for each specified second process block, and
estimating, by the computer, a total update time for the target apparatus by adding the update time for each specified first process block and the update time for each specified second process block.

9. The update time estimating method according to claim 6, wherein:
the target apparatus is one of a plurality of target apparatuses having different apparatus configurations from each other, and the execution order information includes execution order information corresponding to each apparatus configuration, and
the method further comprises:
obtaining, by the computer, from one of the target apparatuses, information indicating an apparatus configuration of the one of the target apparatuses, and
obtaining, by the computer, from the storage device, the execution order information corresponding to the obtained apparatus configuration of the one of the target apparatuses.

10. The update time estimating method according to claim 9, wherein:
the update time information includes an update time corresponding to each of versions of software, and
the method further comprises:
obtaining, by the computer, from one of the target apparatuses, information indicating a version of software before update for the one of the target apparatuses,
extracting, by the computer, from the update time information, an update time corresponding to the obtained version of software of the one of the target apparatuses, and
estimating, by the computer, an update time for each specified first process block and an update time for each specified second process block, using the extracted update time.
